(19) United States
(12) Patent Application Publication
(10) Pub. No.: US 2007/0202957 A1
(43) Pub. Date: Aug. 30, 2007

(54) Gaming machine

(76) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/363,278

(22) Filed: Feb. 28, 2006

(51) Int. Cl. G06F 19/00

(52) U.S. Cl. 463/47; 463/16; 463/30

(57) ABSTRACT

Disclosed is a gaming machine. The gaming machine comprises a main body of the gaming machine playing a game with a predetermined game medium (gaming ball); a figure 40 having a predetermined shape; a base 50 mounted to the main body, the figure 40 being detachably mounted thereto; a sub-CPU 301 for outputting a driving signal when a predetermined condition is fulfilled; and a driving control circuit 309 and a vibration generating device 60 for driving the base 50, based on a driving signal outputted from the sub-CPU 301.

### CROSS-REFERENCE TO RELATED APPLICATIONS

This application is related to a Japanese Patent Application No. 2004-361942, filed on Dec. 14, 2004.

### BACKGROUND OF THE INVENTION

1. Field of the Invention

The present invention relates to a gaming machine such as pachinko gaming machine, and more particularly to a gaming machine having a decoration member detachably mounted thereto.

2. Description of Related Art

As an example of the conventional gaming machines, there is a gaming machine comprising a game board having a figure arranged thereto as a decoration member (for example, a Japanese Unexamined Patent Publication No. 2002-831).

In addition, there is also known a gaming machine wherein a decoration member such as figure is mounted at a predetermined position in a game area and is operated before an identification symbol (special symbol) becomes a predetermined display mode (for example, ready-to-win display mode, big win display mode) in a special symbol display device to carry out an effect, for example, an effect to notify a big win beforehand, in other words, the decoration member is provided with a function as an effect device (for example, a Japanese Unexamined Patent Publication No. 2003-210694).

However, according to the conventional gaming machine, since the decoration member (figure, etc.) is unremovably mounted to the gaming machine, the player has little interest in the decoration member.

In addition, if the decoration member is just detachably structured to enable a player to possess it, the function as an effect device of the decoration member is damaged.

### SUMMARY OF THE INVENTION

Accordingly, the invention has been made to solve the above-mentioned problems occurring in the prior art. An object of the invention is to provide a gaming machine capable of enabling a player to feel a strong affection for a decoration member and enabling the decoration member to have a function as an effect device.

In order to achieve the above object, according to the first invention, there is provided a gaming machine comprising: a main body of the gaming machine playing a game with a predetermined game medium (for example, gaming ball); a decoration member (figure 40) having a predetermined shape; mounting means (base 50) mounted to the main body, the decoration member being detachably mounted thereto; driving signal output means (sub-CPU 301) for outputting a driving signal when a predetermined condition is fulfilled; and driving means (for example, driving control circuit 309, vibration generating device 60) for driving the mounting means, based on a driving signal outputted from the driving signal output means.

According to the invention, since the mounting means is driven by the driving means when a predetermined condition is fulfilled (for example, when a gaming state is shifted to a big win gaming state), the decoration member mounted to the mounting means is also driven correspondingly to the driving of the mounting means, so that it is possible to carry out an effect increasing an interest in a game.

With the above structure, it is possible to provide the decoration member with a function as an effect device.

In addition, since the decoration member is detachably mounted to the mounting means, a player can separate and possess the decoration member, so that it is possible to enable the player to feel a strong affection for the decoration member.

According to the second invention, in addition to the structure of the first invention, the identification information (figure ID) is memorized in the decoration member, it is provided identification information reading means (IC chip reader 52) for reading out the identification information from the decoration member mounted to the mounting means and the output means outputs the driving signal, based on the identification information read out by the identification information reading means.

Accordingly, since the driving signal output means outputs the driving signal, based on the identification information memorized in the decoration member, it is possible to carry out a driving (effect) related to the decoration member, to increase a function as an effect device of the decoration member and to enable the player to feel a strong affection for the decoration member.

According to the third invention, in addition to the structure of the second invention, the driving signal output means determines predetermined identification information when a predetermined condition is fulfilled, and outputs the driving signal when the determined identification information is matched to the identification information read out by the reading means.

Accordingly, since the output means outputs the driving signal when the determined identification information is matched to the identification information of the decoration member mounted to the mounting means, it is possible to make a timing of the driving (effect) different, depending on the decoration members, to increase a function as an effect device of the decoration member and to enable the player to feel a strong affection for the decoration member because a feature depending on the decoration member is clearer.

According to the fourth invention, in addition to the third invention, the gaming machine further comprises big win gaming state determining means (main CPU 201 of a main control circuit 200) for determining whether or not to shift a gaming state to a big win gaming state which is advantageous to a player, when a winning of a gaming ball is made in a winning opening (for example, start winning openings 14, 17) provided to the main body of the gaming machine, wherein the driving signal output means outputs a driving signal corresponding to the big win gaming state when the big win gaming state determining means determines to shift a gaming state to the big win gaming state.

Accordingly, since the mounting means is driven when the big win gaming state determining means determines the big win gaming state, it is possible to increase an interest in a game when the big win is made.

In addition, since the driving signal output means can output different driving signals in accordance with types of the big win, it is possible to make types of the decoration member to be driven (effected) different in correspondence with the types of the decoration member. Accordingly, it is possible to enable the player to feel a strong affection for the decoration member because a feature depending on the decoration member is clearer.

According to the fifth invention, in addition to the fourth invention, the gaming machine further comprises a changeable display device (liquid crystal display device 21) for variably displaying the identification symbol (special symbol) and identification symbol variable display control means (main CPU 201 of a main control circuit 200) for controlling a variable display of an identification symbol for enabling the changeable display device to variably display the identification symbol, wherein the identification symbol variable display control means stops the identification symbol as a predetermined big win display mode in the changeable display device after the big win gaming state determining means determines to shift a gaming state to the big win gaming state and the driving signal output means outputs the driving signal corresponding to the big win gaming state.

Accordingly, when the big win gaming state determining means determines the big win, since it is possible to drive the mounting means before the identification symbol is stopped as a big win display mode representing that the big win is made in the changeable display device, it is possible to carry out an effect as a preliminary notice through the driving and to increase the function as an effect device of the decoration member much more.

According to the sixth invention, in addition to the first invention, the gaming machine further comprises a tray unit (tray unit 5) having a storing part for storing the game medium and a flow passage (flow passage 65) enabling the game medium to flow, wherein the mounting means is positioned in the tray unit.

Accordingly, since the vibration resulting from the driving of the mounting means is transmitted to the flow passage, it is possible to improve the flowing state of the game medium in the flow passage through the vibration, thereby preventing the gaming ball from being jammed.

According to the seventh invention, in addition to the first invention, the driving signal output means outputs the driving signal corresponding to the identification information provided to each of the plural detachable decoration members having types different from each other.

Accordingly, when any one of the plural detachable decoration members having types different from each other is mounted to the mounting means, it is possible to enable the mounting means to carry out the driving (effect) related to the driving signal corresponding to the identification information provided to the decoration member. Therefore, it is possible to further increase the function as an effect device of the decoration member and to enable the player to feel a strong affection for the decoration member.

### BRIEF DESCRIPTION OF THE DRAWINGS

Other and further objects, features and advantages of the invention will appear more fully from the following description taken in connection with the accompanying drawings, in which:

FIG. 1 is a perspective view showing a structure of a gaming machine according to an embodiment of the invention;

FIG. 2 is a front view of a game board according to an embodiment of the invention;

FIG. 3 is an exploded perspective view showing a structure of a decoration member according to an embodiment of the invention;

FIG. 4 is a perspective view of a base according to an embodiment of the invention;

FIG. 5 is a plan view of a base according to an embodiment of the invention;

FIG. 6 is a sectional view taken along a line A-A shown in FIG. 5;

FIG. 7 is a perspective view showing a decoration member mounted to a base, according to an embodiment of the invention;

FIG. 8A illustrates that gaming balls are jammed in a flow passage;

FIG. 8B illustrates that vibration resulting from a driving of a base is transmitted in a flow passage;

FIG. 8C illustrates that vibration resulting from a driving of a base is transmitted in a flow passage;

FIG. 9 is a block diagram showing a control system of the gaming machine shown in FIG. 1;

FIG. 10 is a block diagram showing a detailed structure of an image control circuit shown in FIG. 9;

FIG. 11 is a view showing an example of a vibration pattern table according to an embodiment of the invention;

FIG. 12 is a flow chart showing a process operation of a main control circuit of a gaming machine according to an embodiment of the invention;

FIG. 13 is a flow chart showing a special symbol control process operation according to an embodiment of the invention;

FIG. 14 is flow chart showing a special symbol memory checking process operation according to an embodiment of the invention;

FIG. 15 is a view showing an example of a variable display pattern selecting table according to an embodiment of the invention;

FIG. 16 is a flow chart showing a main process of a sub-control circuit of a gaming machine according to an embodiment of the invention;

FIG. 17 is a flow chart showing a command receiving intervention process according to an embodiment of the invention;

FIG. 18 is a flow chart showing a figure authenticating process according to an embodiment of the invention;

FIG. 19 is a flow chart showing a command analyzing process according to an embodiment of the invention; and

FIG. 20 is a flow chart showing a base vibration process according to an embodiment of the invention.

### DESCRIPTION OF THE PREFERRED EMBODIMENTS

Hereinafter, it will be described a preferred embodiment of the present invention with reference to the drawings. In the flowing descriptions, the same reference numerals are used to refer to a same member and the overlapping explanation is omitted. In the mean time, the descriptions are provided to illustrate a best mode of the invention, not to limit the invention.

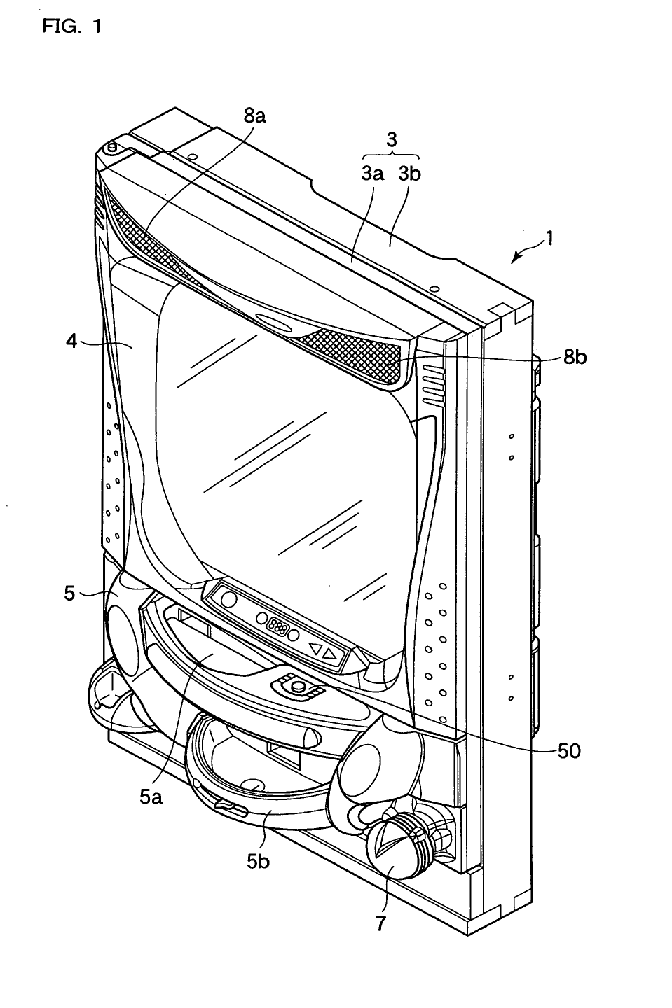

Hereinafter, it is described a structure of a bullet ball gaming machine (referred to as a gaming machine) 1, with reference to the drawings. FIGS. 1 to 20 show an embodiment of the gaming machine 1 of a pre-paid card manner.

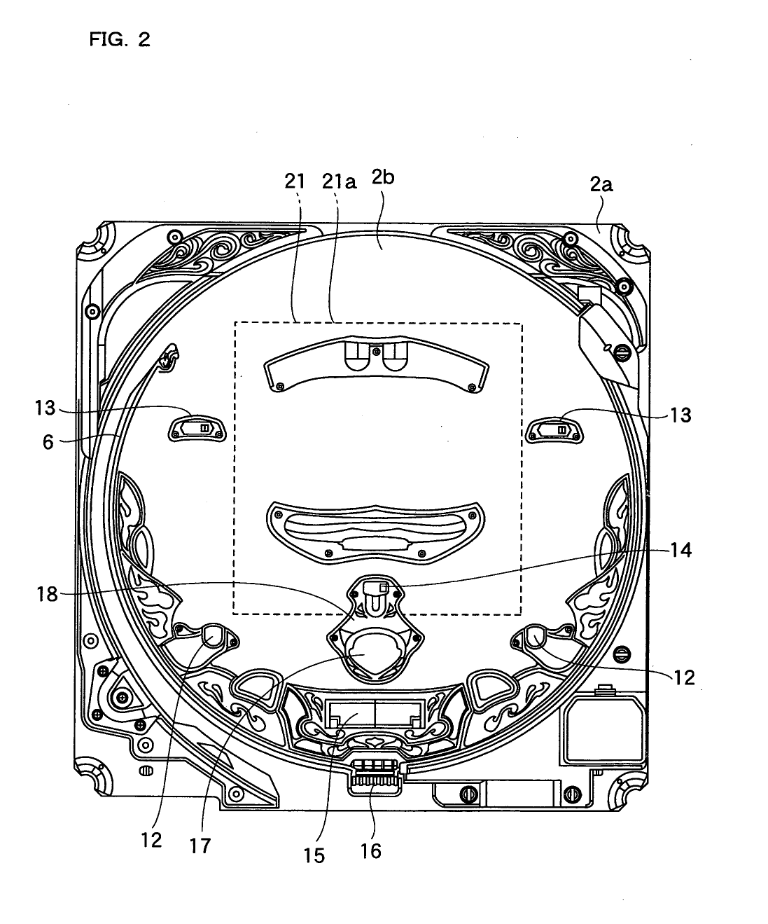

First, it is described a structure of the pachinko gaming machine 1 with reference to FIGS. 1 and 2. In the mean time, FIG. 1 is a perspective view showing a structure of the gaming machine according to an embodiment of the invention, and FIG. 2 is a front view of a game board according to the embodiment.

As shown in FIGS. 1 and 2, the pachinko gaming machine (gaming machine) 1 comprises a main body 3 of the gaming machine, which consists of a main frame 3a having a game board 2a (see FIG. 2) mounted thereto and a base frame 3b, wherein the main frame 3a is rotatably attached to the base frame 3b which is fixed to an island equipment through a hinge (i.e., the main frame 3a is supported at a rotation supporting point of an end of the main frame 3a and attached to the base frame 3b to be opened/closed). A glass door 4 enabling the game board 2a to be visible and a tray unit 5 located below the glass door 4 are provided to the main body 3. The glass door 4 and the tray unit 5 are axis-supported at an end thereof to be rotatable with regard to the main body 3 and engaged at the other end with the main body 3.

In addition, in the embodiment, the main body 3 and the tray unit 5 are defined as a main body of a gaming machine in a broad sense (hereinafter, referred to as a broad sense of a gaming machine).

The game board 2a (see FIG. 2) has a game area 2b which is surrounded by a rail 6 and enables a gaming ball to move downward. In the game area 2b, there is arranged a game member consisting of an obstacle such as plural nails, windmill and the like, a regular winning opening 12, a passage gate 13, a special winning opening 15 which is a changeable winning device, an outlet 16, and an electronic accessory member 18 having start winning openings 14, 17.

In addition, a liquid crystal display device (LCD) 21 having a display area 21a capable of displaying an effect image (for example, animation or notification information corresponding to a gaming state, hereinafter, referred to as ┌effect information image┘) is arranged at a rear of the game board 2a.

In addition, the display area 21a of the liquid crystal display device 21 comprises an area for displaying an effect image, an ordinary symbol display area (ordinary symbol display device) for variably displaying an ordinary symbol and a special symbol display area (special symbol display device) for variably displaying a special symbol.

In addition, in the embodiment, the display area 21a having a square shape may be larger or smaller than the game area 2b. In addition, the shape of the display area 21a is not limited to the square shape. In other words, the display area may be formed into an arbitrary shape such as a circular shape.

The regular winning opening 12 is a device for paying out the predetermined number of gaming balls when a winning of the gaming ball is made, the passage gate 13 is a device for variably displaying and stopping a plurality of symbols which are displayed in the ordinary symbol display area when the gaming ball passes to it, the start winning openings 14, 17 are devices for variably displaying and stopping a special symbol which is displayed in the special symbol display area on condition that a winning of the gaming ball is made, and the special winning opening 15 is a device which is controlled so that the door is opened or opened as the predetermined number of times under predetermined condition in accordance with a predetermined setting when a combination of special symbols at the stopping time of the special symbol display area becomes a combination of specific symbols preset (a big win display mode) and thus a gaming state is shifted to a big win gaming state (the big win gaming state is meant by a state in which a so-called big win occurs) (i.e., the special winning opening 15 is opened only when the number of the gaming ball passing to a specific area of the special winning opening 15 within a predetermined time period is 1 or more (i.e., as long as there no-passage does not occur), so that it is changed as the predetermined number of times between an opened state at which it is easy to accept the gaming ball and a closed state at which it is difficult to accept the gaming ball. In the mean time, the changing operation between the opened state and the closed state is referred to as a round operation).

The outlet 16 is a device in which the gaming ball whose winning is not made in any of the regular winning opening 12, the start winning openings 14, 17 and the special winning opening 15 is collected.

The liquid crystal display device 21 which is variable display means is a device for displaying any image in the display area 21a, based on an instruction from an image control circuit 305 which will be described later.

In addition, in the embodiment in which the game board 2a is clear, the display area 21a of the liquid crystal display device 21 can be visible through the game board 2a. In addition to the liquid crystal display device 21, a CRT (Cathode Ray Tube) or plasma display can be used.

As shown in FIG. 1, the tray unit 5 is arranged below the game board 2a. An upper tray 5a is arranged above the tray unit 5, in which the paid out gaming ball and the gaming ball shot in the game area are deposited, and a lower tray 5b is arranged below the tray unit 5, in which the gaming balls overflowing the upper tray 5a through the payout are deposited. In addition, a shutter lever (not shown), which is manipulated in case of moving the gaming ball deposited in the upper tray 5a into the lower tray 5b at the time of the game ending, and a base 50 (which will be described in detail) to which a decoration member is mounted are arranged in predetermined positions of the upper tray 5a.

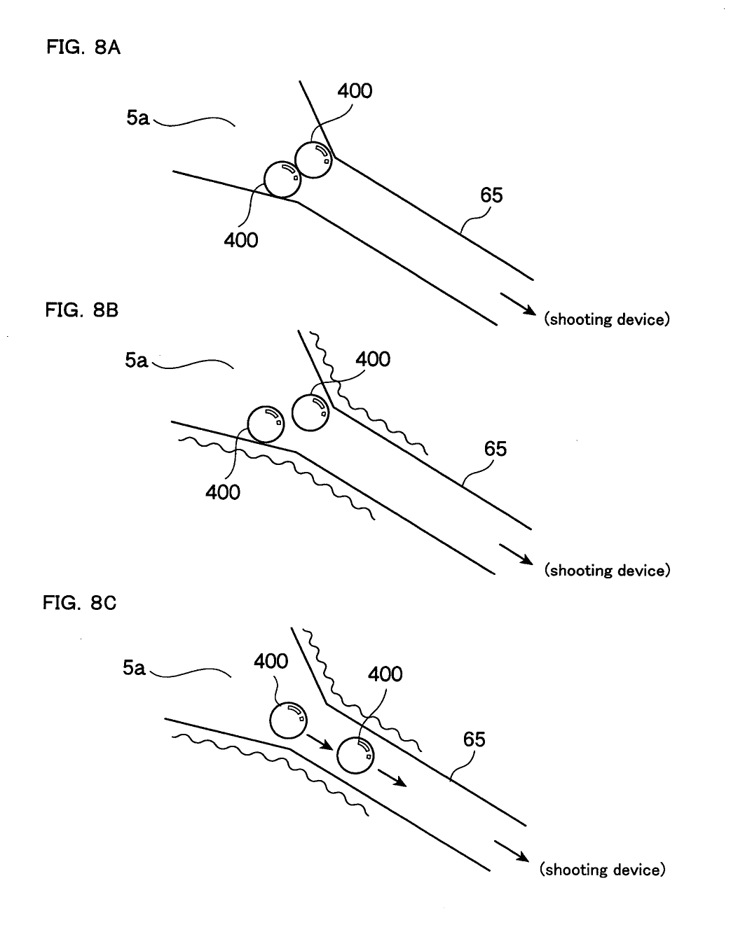

In addition, a flow passage 65 (see FIG. 8) for enabling a gaming ball to flow is provided in the tray unit 5. The gaming balls deposited in the upper tray 5a are adapted to flow into a shooting device 90 through the flow passage 65. The gaming balls having flown in the shooting device 90 is shot toward the game area 2b by the shooting device 90.

To a right side of the tray unit 5 is mounted a handle 7 which is rotation-operated when the gaming ball is shot to the game area of the game board 2a thorough the rail 6. The handle 7 is provided with a stop button (not shown) for stopping the shooting of the gaming ball.

In addition, speakers 8a, 8b are mounted at upper left and right sides above the glass door 4.

The passage gate 13 is adapted to detect the gaming ball which passes to it. The passing ball of the passage gate 13 is adapted such that a reservation memory thereof can be made, and it is carried out a variable display of a symbol in the ordinary symbol display area, based on the passing memory information. In addition, to an upper right side of the game area 2b are four ordinary symbol memory LEDs (not shown) for displaying the passing memory-number of the passage gate 13. The passing memory-number of the gaming balls having passed to the passage gate 13 can be displayed by the number of the LEDs turned on.

In the ordinary symbol display area, for example two ordinary symbols are adapted to be alternately turned on or off. When the lighting-up and lights-out of the two ordinary symbols are ended and thus a ┌win┘ is displayed, the start winning opening 17 provided to the electronic accessory member 18 is switched to a state under which it is easy to accept the gaming ball for a predetermined time period.

In addition, it may be such structured that the two ordinary symbol display LEDs are provided to any place of the game board 2a, rather than the ordinary symbol display area and a ┌win┘ is displayed by the lighting-up and lights-out of the LEDs. In addition, the two ordinary symbol display LEDs may consist of 7 segment displayers, for example. In this case, the numbers, for example ┌0┘, ┌1┘, ┌2┘, . . . ┌7┘, ┌8┘, ┌9┘ are variably displayed as the ordinary symbol to be displayed on the 7 segment displayers and a ┌win┘ is determined when the stopped number is ┌3┘ or ┌7┘.

The start winning opening 17 is provided with a receiving slot accepting the gaming ball and is a device having an opening/closing unit capable of being switched between a state at which it is easy to accept the gaming ball and a state at which it is difficult to accept the gaming ball. The start winning opening 17 is under state at which it is difficult to accept the gaming ball in a usual state and then can be switched into the state at which the opening is opened for a predetermined time period (for example, 0.3 second) and thus it is easy to accept the gaming ball, when a predetermined condition is fulfilled (for example, when the ordinary symbol of the ordinary symbol display area is stopped at a symbol representing a ┌win┘). In the mean time, when a winning of the gaming is made in the receiving slot, the predetermined number of gaming balls is paid out.

In addition, the winning ball for the start winning openings 14, 17 is adapted such that a winning memory thereof can be made. A variable display of the special symbol is carried out in the special symbol display area on the basis of the winning memory. Four special symbol memory LEDs (not shown) for displaying the winning memory-number for the start winning openings 14, 17 are arranged at a center of the game area 2b. The winning memory-number for the start winning openings 14, 17 can be displayed by the number of the special symbol memory LEDs turned on.

In addition, the special symbol to be displayed in the special symbol display area consists of three rows of numerals such as ┌0┘, ┌1┘, ┌2┘, . . . ┌9┘, and the numerals are variably displayed when a winning of the gaming ball is made in the start winning opening 17. In the mean time, when the variable display of the numerals are ended and a result of the variable display (i.e., a combination of numerals stopped and referred to as stop symbols) becomes a predetermined pattern in which three same numbers are arranged such as [┌0┘ ┌0┘ ┌0┘ ┌0┘], [┌7┘ ┌7┘ ┌7┘ ], a combination of special symbols at that time is referred to as a big win display mode (big win symbol). The big win display mode is a display mode for enabling a player to perceive that a gaming state is shifted to a big win gaming state (i.e., a ┌big win┘ is made) which is advantageous to the player, as compared to a base gaming state. In the mean time, a result of the variable display except the big win display mode is referred to as a non-big win display mode (losing symbol).

In addition, the big win gaming state is a gaming state at which a special winning opening SOL 72S opens and closes the door of the special winning opening 15 by the predetermined number of times, so that a winning of the more gaming balls is easily made, as compared to the base gaming state.

In the mean time, the big win display mode for enabling a player to perceive that a gaming state is shifted to the big win gaming state is divided into a special display mode (probability-variable big win symbol) which is a display mode representing a probability-variable big win and a non-special display mode (usual big win symbol) which is a display mode representing a usual big win.

In addition, the special display mode is a case where three predetermined numerals such as ┌7┘ or ┌3┘ are matched, and the non-special display mode is a case where three numerals except the special display mode are matched.

In the mean time, when a variable display result of the special symbol becomes the special display mode (i.e., probability-variable big win), the gaming state is shifted to a special gaming state (probability-variable state) at which it is higher a probability that a variable display result of the special symbol in the special symbol display area will be the big win display mode after the big win gaming state is over. In the mean time, when a display mode of the special symbol becomes the non-special display mode (i.e., usual big win), the gaming state is shifted to the base gaming state after the big win gaming state is over.

In addition, in the embodiment, the winning memory-number and the passing memory-number are respectively displayed by the ordinary symbol memory LEDs and the special symbol memory LEDs. However, the invention is not limited thereto and they may be displayed by another display method. For example, they may be displayed in the display area 21a.

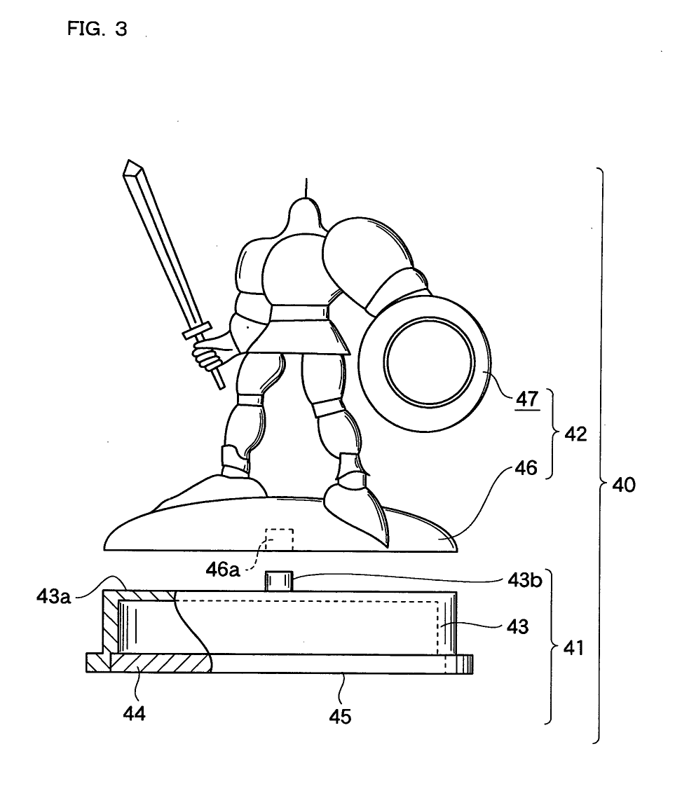

In the followings, it is described a structure of a decoration member 40 with reference to FIG. 3. In the mean time, FIG. 3 is an exploded perspective view showing a structure of a decoration member according to an embodiment of the invention.

The decoration member 40 is a decoration member (hereinafter, referred to as a figure) such as figures corresponding to plural characters. As shown in FIG. 3, the decoration member comprises a base portion 41 and a figure main body 42 expressing a solid shape of each character and is detachably mounted to a base 50 which will be described later. In the mean time, a bottom of the base portion 41 constitutes a bottom section 45.

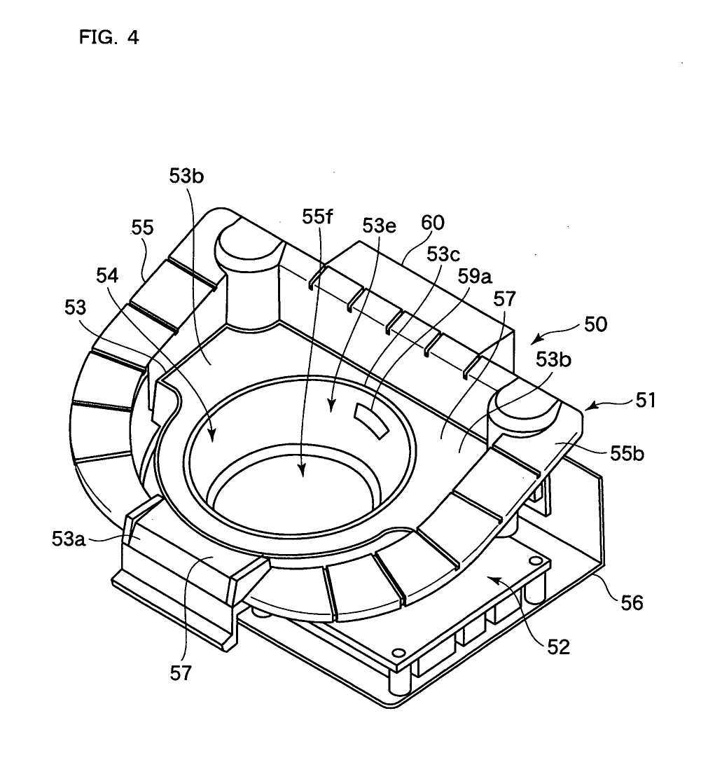

The base portion 41 has a size corresponding to a base mounting part 51 (see FIG. 4) and is formed into a hollow thick disk shape. The base portion 41 comprises a cylindrical bottomed base main body 43 having a ceiling section 43a and an IC chip 44. A protrusion 43b is provided to a center of the ceiling section 43a of the base main body 43 and the IC chip 44 is fitted in an opened end of the base main body 43. In addition, an annular protrusion is formed at an outer periphery of the opened end to constitute the bottom section 45. The IC chip 44 memorizes the identification information (identification information inherent to a character) corresponding to the figure main body 42.

The figure main body 42 comprises a leg resting section 46 having a recess 46a corresponding to the protrusion 43b and a figure part 47 adapted to stand up straight from the leg resting section 46 with two legs and imitating each character. The protrusion 43b is fitted into the recess 46a, so that the figure main body is fixed to the ceiling section 43a of the base portion 41.

The player can distinguish the figure 40 in accordance with the shape of the figure main body 42 and the pachinko gaming machine 1 can discriminate the figure through the inherent identification information. In the embodiment, the inherent identification information (hereinafter, referred to as figure ID) corresponding to the figure 40 (specifically, figure main body 42) has a same unique with regard to the same figure 40. In other words, in plural figures having the types different from each other, a same figure ID is provided to correspond to a same type of a figure. For example, if there are 5 types of figures, 5 figure IDs are provided.

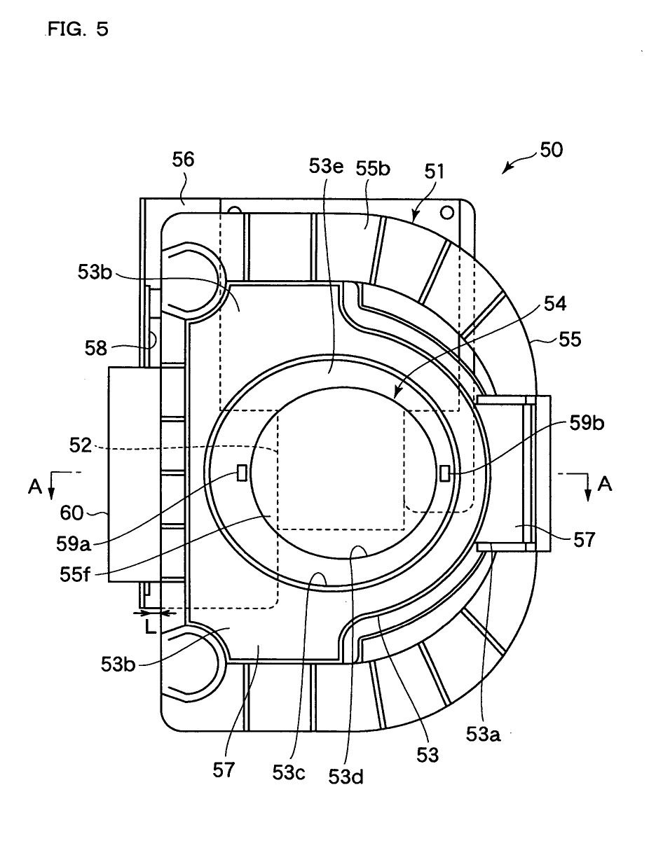

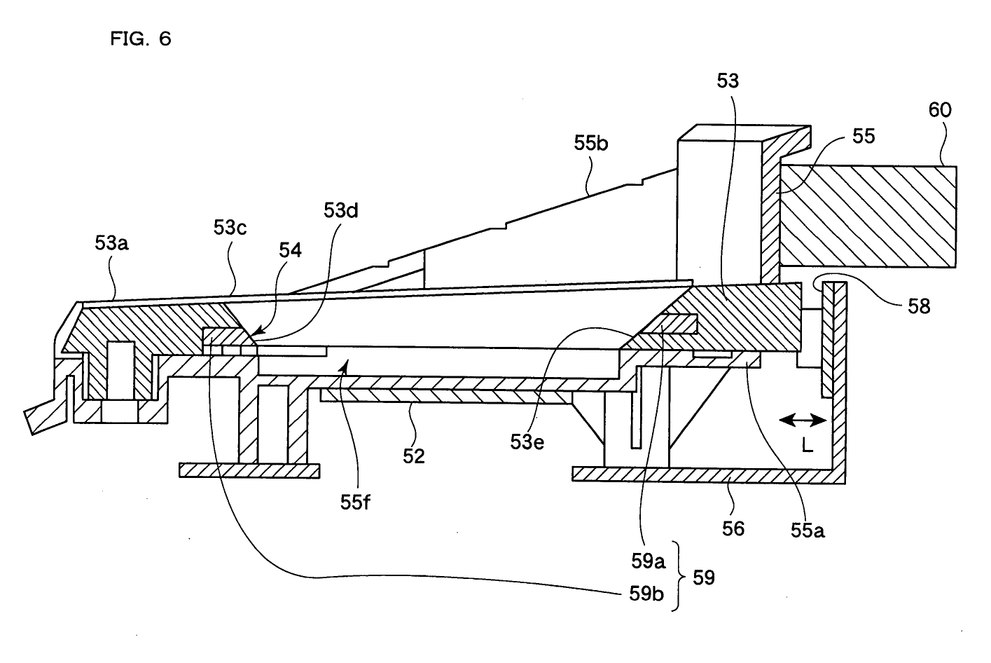

In the followings, it is described a structure of a base 50 to which the detachable figure 40 is mounted and which is mounted at a predetermined position of the upper tray 5a, with reference to FIGS. 4 to 6. In the mean time, FIG. 4 is a perspective view showing a base according to an embodiment, FIG. 5 is a plan view of the base and FIG. 6 is a sectional view taken along a line A-A shown in FIG. 4.

The base (mounting means) 50 is mounted to the main body of the gaming machine in a broad sense and has a structure to which the figure 40 is detachably mounted.

As shown in FIG. 4, the base 50 comprises a base mounting part 51, an IC chip reader 52 for reading out the figure ID memorized in the IC chip 44 of the figure 40 and a photo sensor 59 for detecting that the figure 40 is mounted at a readable position of the figure ID which can be read out by the IC chip reader 52. Hereinafter, it will be specifically described with reference to FIGS. 4 to 6.

The base mounting part 51 comprises a guide member 53 having a guide opening 54 therein and consisting of a light transmitting member such as transparent urethane, a support frame 55 for supporting the guide member 53 from a periphery and a lower part and a pedestal 56 for fixing the support frame 55 and the guide member 53 to the upper tray 5a (see FIG. 1) provided to the gaming machine in a broad sense.

In addition, to the rear of the support frame 55 is attached a vibration generating device (driving means) 60 for driving the base 50 with vibrations.

The guide member 53 is formed into an approximate disc shape having the guide opening 54 therein and provided with a protrusion 53a at a front side (toward the player) and widened sections 53b, 53b at a rear side. A bottom of the protrusion 53a of the guide member 53 is assembled to the support member 55 and the widened sections 53b, 53b are fitted thereto.

In addition, the guide member 53 is formed with a circular opening 53d of a side of the pedestal 56 (a side closed by a seat 55a of the support frame 55) facing the guide opening 54 and a circular open end 53c of an opened side thereof. A diameter of the open end 53c is larger than that of the opening 53d and a peripheral surface between the open end 53c and the opening 53d is shaped into a conical inclined surface 53e whose diameter is gradually reduced from the open end 53c to the opening 53d. A shape of the opening 53d corresponds to that of the bottom section 45 of the figure 40, which can be inserted into the opening.

The support frame 55 comprises an annular frame body 55b surrounding the guide member 53, a support bearing section 55a concaved in the frame body 55a and supporting the guide member 53 and a cylindrical depression 55f formed to have a step at a center of the support bearing section 55a. An opening of the depression 55f is concentric with the opening 53d of the guide member 53 and has a diameter same as that of the opening 53d. In addition, a bottom of the depression 55f is a circular plane corresponding to the opening 53d and a peripheral surface of the depression 55f is a cylindrical surface corresponding to the opening 53d. As a consequence, the depression 55f is structured to correspond to the external shape of the bottom section 45 of the figure 40 and thus to receive the bottom section 45 therein.

The photo sensor 59 comprises a light emitting part 59a for emitting the light such as infrared toward a light receiving part 59b and a light receiving part 59b capable of receiving the light from the light emitting part 59a. In addition, the light emitting part 59a is provided to the conical inclined surface 53e at the rear of the guide member 53 and the light receiving part 59b is provided to the conical inclined surface 53e opposite to the light emitting part 59a with the opening 53d being located therebetween. Accordingly, the light emitting part 59a and the light receiving part 59b of the photo sensor 59 are positioned to be opposite to each other with an entrance path of the bottom section 45 facing the depression 55f being located therebetween. When the bottom section 45 is received in the depression 55f, the light which is received in the light receiving part 59b is interrupted by the figure 40. As a result, the photo sensor can detect that the figure 40 is located at a reading position.

A detection signal representing whether the figure 40 is mounted at the readable position (i.e., whether the figure 40 is mounted at the base 50) is transmitted to a sub-control circuit 300 from the photo sensor 59.

When the figure (decoration member) 40 is mounted at the base (mounting means) 50, the IC chip reader 52 serves as the identification information reading means for reading out the figure ID (identification information) from the corresponding figure 40 and comprises an antenna or wireless circuit on a convex board. The antenna is fixed to the pedestal 56 so that it is located adjacent to the center of the bottom of the depression 55f so as to read out the identification information (referred to as figure ID) provided to the figure 40 when the bottom section 45 of the figure 40 (see FIG. 6) is accommodated in the depression 55f. In the mean time, when the bottom section 45 is accommodated in the depression 55f, it is possible to read out the figure ID at the position (reading position) with the IC chip reader 52.

As described above, when the figure 40 is mounted to the base 50, the IC chip reader 52 can read out the figure ID through the communication with the IC chip 44 of the figure 40. However, in the embodiment, in order to authenticate the figure with a sub-control circuit 300, the IC chip reader 52 reads out the figure ID through the communication with the IC chip 44 when there is a request for the reading of the figure ID from the sub-control circuit 300 and transmits the read figure ID to the sub-control circuit 300.

Full color LEDs 58 which are a light source are mounted at the rear of the guide member 53 at an interval L (about 5 mm). In addition, a black light-shielding seal 57 is attached to a place which is not surrounded by the support frame 55, except the conical inclined surface 53e, with regard to the outer periphery of the guide member 53. The full color LEDs 58 are supplied with the power from a driving circuit (not shown) to emit the light toward the guide member 53. Then, the light having transmitted the guide member 53 is discharged from the conical inclined surface 53e.

The vibration generating device 60 having a rectangular shape attached to the rear of the support frame 55 is a device which generates the vibrations under control of the sub-control circuit 300 to drive the base 50.

Herein, the ┌vibration generating device┘ is meant by a device for generating and transmitting vibration to the other structures or devices. The vibration generating device which can be used for the gaming machine of the invention includes, for example an unbalance mass-type vibration generating device having a mass (weight) eccentric to a rotation axis of a motor and generating the vibration with a centrifugal force resulting from the rotation thereof, a conductive-type vibration generating device capable of enabling the electric current to flow to a coil in a magnetic filed in accordance with a Fleming's left-hand rule, thereby generating the vibration, etc.

According to the invention, the device for driving the base 50 is not particularly limited. For example, a device besides the unbalance mass-type vibration generating device and the conductive-type vibration generating device may be used. In addition to the vibration, a circular motion which slowly rotates in a horizontal or vertical direction may be used to drive the base 50.

In addition, in the embodiment, the vibration generating device 60 is adapted to generate the vibration under control of the driving control circuit 309 of the sub-control circuit 300 when a predetermined condition is fulfilled.

In addition, in the embodiment, the vibration generating device 60 can generate a variety of patterns of vibrations under control of the driving control circuit 309. For example, the patterns include a pattern for intermittently generating the vibration having a predetermined magnitude, a pattern for continuing the vibration having a predetermined magnitude for a predetermined time period, etc.

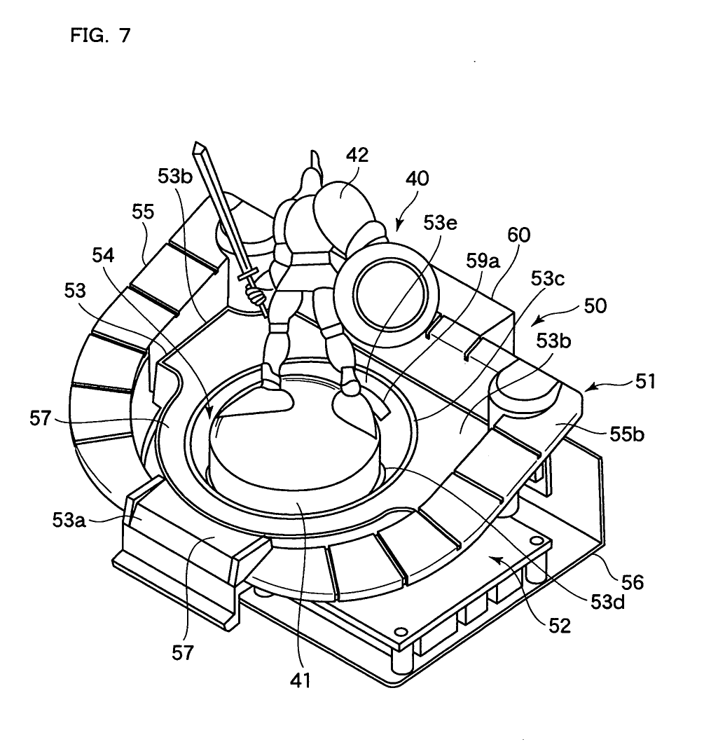

FIG. 7 shows that the figure 40 (specifically, bottom section 45) shown in FIG. 3 is mounted to the base 50 (specifically, depression 550 shown in FIG. 4. In the mean time, FIG. 7 is a perspective view showing the figure 40 mounted to the base 50.

In addition, when the base 50 is driven by the vibration generated from the vibration generating device 60, the figure 40 mounted to the base 50 is also driven in accordance with the driving of the base 50.

In addition, since the vibration resulting from the driving of the base 50 is also transmitted to the flow passage 65 provided in the tray unit 5, it is possible to improve the flowing state of the game medium in the flow passage 65 through the vibration, thereby preventing the gaming ball from being jammed in the flow passage 65.

Hereinafter, it is described an example of an improvement of the flowing state of the gaming ball in the flow passage 65, with reference to FIG. 8.

FIGS. 8A to 8C illustrate gaming balls in the flow passage. In addition, the flow passage 65 is a flow path for connecting the upper tray 5a and the shooting device 90 and is inclined toward the shooting device 90.

FIG. 8A illustrates that gaming balls are jammed in a flow passage. In FIG. 8A, it is shown that the two gaming balls 400 are collided with each other just before entering a narrow area of the flow passage 65 and thus are jammed. In the convention gaming machines, such situation often occurs in the flow passage 65.

FIGS. 8B and 8C illustrate that the vibrations resulting from the driving of the base 50 are transmitted in the flow passage 65. As shown in FIG. 8B, when the vibrations are transmitted in the flow passage 65, the gaming balls 400 are vibrated, so that there occurs a gap between the gaming balls collided with each other. Thereby, as shown in FIG. 8C, the gaming balls 400 can flow in the flow passage one by one, so that the flowing state in the flow passage 65 is improved.

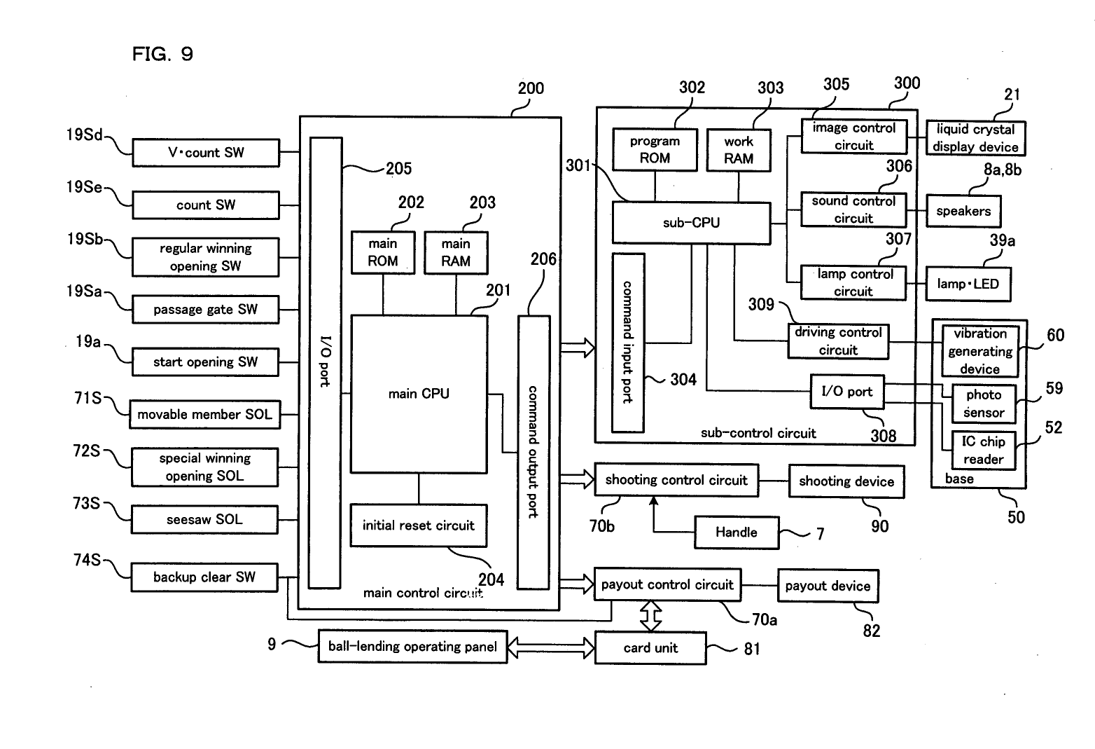

In the followings, it is described a control system of the pachinko gaming machine 1 shown in FIG. 1, with reference to FIG. 9. In the mean time, FIG. 9 is a block diagram showing a control system of the gaming machine shown in FIG. 1.

The control system of the pachinko gaming machine 1 comprises a main control circuit 200 and a sub-control circuit 300, a payout control circuit 70a and a shooting control circuit 70 which are connected to the main control circuit 200. The control system is mounted at the rear of the game board 2a.

A card unit 81 is connected to the payout control circuit 70a of the pachinko gaming machine 1.

The card unit 81 is mounted adjacent to the pachinko gaming machine 1 and is formed with an insertion slot through which a pre-paid card can be inserted. The card unit comprises means for reading out the record information recorded in the pre-paid card inserted into the insertion slot, means for outputting a lending command signal to instruct the payout control circuit 70a to lend a gaming ball in accordance with the operation of the shutter lever and means for subtracting the number of lending balls instructed by the output means from the possible number of lending balls specified by the record information read out by the reading means and recording the corresponding information to the pre-paid card inserted into the insertion slot.

The main control circuit 200 is provided with a main CPU (subminiature arithmetic processing device) 201 for carrying out a game process of the pachinko gaming machine 1 in accordance with a preset program, an initial reset circuit 204 for generating a reset signal so as to restore the various settings to initial values thereof when there occurs an abnormal situation or when the power is inputted, a main RAM 203 for memorizing various data or command necessary for the operations of the main CPU 201 and a main ROM 202 for storing a program to control the game progress of the gaming machine 1, a big win determining table which is referred to when it is carried out a big win determination by a random number lottery, an ordinary win determining table which is referred to when it is carried out an ordinary win determination by a random number lottery, a win variable display pattern determining table and a losing variable display pattern table which are referred to when it is determined a variable display pattern of a special symbol by a random number lottery, an effect image display pattern determining table which is referred to when it is determined an effect information image such as character image or background image by a random number lottery and various probability tables which are referred to when it is carried out a lottery for the other effects.

The main RAM 203 is provided with a winning memory counter for memorizing a winning memory-number (the number of winning balls regarding the start winning openings 14, 17) counted by the main CPU 201, a passing memory counter for memorizing the passing memory-number (the number of balls having passed to the passage gate 13) counted by the main CPU 201, a special winning opening-winning counter for memorizing the number of gaming balls which are accepted in the special winning opening 15 during one time round and a counter for memorizing the number of cases where the special winning opening 15 is opened during one big win gaming state.

The main CPU 201 has each functions of the means for determining a big win gaming state, the means for controlling a variable display of an identification symbol, the means for transmitting an effect command for preliminarily notifying a ready-to-win, the means for shifting a gaming state and the means for controlling a winning opening SOL.

The means for determining a big win gaming state determines to shift a gaming state to a big win gaming state which is advantageous to the player when a winning of the gaming ball is made in the winning openings (start winning openings 14, 17) provided to the main body of the gaming machine in a broad sense (or the main body 3 of the gaming machine).

For example, the means for determining a big win gaming state carries out a big win determining process, based on a random number value for determining a big win which is sampled by a random number lottery, when a winning of the gaming ball is made in the start winning openings 14, 17. When it is determined through the determining process that it is made a big win, the means determines to shift a gaming sate to a big win gaming state.

Herein, when it is determined that the gaming state is shifted to the big win gaming state by the means for determining a big win gaming state, the means for shifting a gaming state shifts the gaming state to the big win gaming state after the variable display of the special symbol by means for variably displaying an identification symbol is ended, i.e., after a big win display mode (big win symbol) is displayed in the special symbol display area.

In the mean time, as described above, the big win includes a usual big win and a probability-variable big win. In case of the probability-variable big win, the gaming state is shifted to a special gaming state, in which it is high a probability that a gaming state will be a big win gaming state next time, by the means for shifting a gaming state, after the big win gaming state is over.

In addition, the means for controlling a variable display of an identification symbol is provided to generate and set a variable display pattern command so as to variably display a special symbol in the special symbol display area, and determines a variable display pattern for carrying out a variable display of a special symbol, based on a big win determination result of the means for determining a big win gaming state.

Specifically, the means for controlling a variable display of an identification symbol generates and sets a variable display pattern command instructing a variable display pattern for carrying out a variable display of the special symbol or a display of the effect information and a command instructing a stop symbol of the variable display, based on a big win determination result of the means for determining a big win gaming state.

The variable display pattern includes a special symbol display pattern and an effect information display pattern. Accordingly, the variable display pattern command includes the data for instructing the special symbol display pattern and the data for instructing the effect information display pattern.

The special symbol display pattern is a variable display pattern of a special symbol which is variably displayed in the special symbol display area, for example three special symbols. In addition, the special symbol display pattern also includes the display time information representing the respective display time of the three special symbols (for example, ┌left┘, ┌center┘ and ┌right┘). Accordingly, the special symbol display pattern includes the display pattern and the time information.

In addition, the effect information display pattern is a pattern related to a display of the effect information such as character. Accordingly, it is prepared the effect information display patterns in correspondence with the number of characters and it is indicated (instructed) an effect information display pattern of the effect information (effect information image) which is actually displayed, among the plural effect information display patters.

In case that the determined variable display pattern of a special symbol is a ready-to-win (for example, a normal ready-to-win, a winning of a normal ready-to-win, a super ready-to-win, a winning of a super ready-to-win, etc.), the means for transmitting an effect command for preliminarily notifying a ready-to-win transmits an effect command for preliminarily notifying a ready-to-win relating to a preliminary notice instruction of a ready-to-win to the sub-control circuit 300 before the corresponding ready-to-win is displayed in the liquid crystal display device 21.

The means for controlling a winning opening SOL controls a special winning opening SOL 72S to open/close the door of the special winning opening 15 (to open the special winning opening), when the gaming state is shifted to the big win gaming state.

The programs for embodying the functions of the respective means are stored in the main ROM 202. The main CPU 201 may load and execute the respective programs from the main ROM 202 to the main RAM 203, thereby embodying the above functions of the respective means. It is needless to say that the respective means may consist of a dedicated hardware.

In addition, the main CPU 201 carries out a process of determining contents which are displayed in the ordinary symbol display area, and the like.

The main CPU 201 carries out the functions of the respective means to transmit various commands, such as a command related to a game effect instruction, to the sub-control circuit 300 to execute the corresponding effect.

The command related to a game effect instruction includes a command related to a display effect instruction by the display means such as liquid crystal monitor, a command related to a sound effect instruction by sound generating means such as speaker and a command related to a light effect instruction by the light emitting means such as lamp or LED.

In addition, the command related to a display effect instruction includes various commands such as variable display pattern command and effect command for preliminarily notifying a ready-to-win, etc.

The variable display pattern command includes the data for instructing the special symbol display pattern, the effect information display pattern, respectively, as described above, and also the information of a flag for notifying a game beforehand.

The flag for notifying a game beforehand is a flag including the information for previously notifying whether a big win display mode becomes a special display mode (probability-variable big win symbol) or non-special display mode (usual big win symbol) when a combination of special symbols, which are displayed in the special symbol display area by the means for controlling a variable display of an identification symbol, a big win display mode (big win symbol).

For example, in case that a value (1) representing a usual big win is set in the flag for notifying a game beforehand, it is preliminarily notified that a non-special display mode (usual big win symbol) will be stopped in the special symbol display area. In the mean time, in case that a value (2) representing a probability-variable big win is set in the flag for notifying a game beforehand, it is preliminarily notified that a special display mode (probability-variable big win symbol) will be stopped in the special symbol display area.

To the I/O port 205 of the main control circuit 200 is connected a passage gate SW 19Sa which is a sensor for detecting a passing of the gaming ball and a start opening SW 19a which is a sensor for detecting a gaming ball whose winning is made in the start winning openings 14, 17, which sensors are mounted in the passage gate 13.

In addition, to the I/O port 205 is connected a V•count SW 19Sd which is a sensor mounted to a continuation winning opening in the special winning opening 15 and detecting a gaming ball whose winning is made, a count SW 19Se which is a sensor mounted to the ordinary winning opening in the special winning opening 15 and detecting a gaming ball whose winning is made, a regular winning opening SW 19Sb which is a sensor detecting a gaming ball whose winning is made in the regular winning opening 12 and a backup clear SW 74S for erasing the various data memorized in the main RAM 203.

In addition, to the I/O port 205 is connected sensors such as a shooting ball sensor (not shown) for detecting a gaming ball which is shot from the shooting device 90 through the operation of the handle 7 and a return ball sensor (not shown) for detecting a gaming ball which is shot but returned to the rail 6 without reaching the board surface of the game board 2a, and actuators such as a movable member SOL (solenoid) 71S for switching the start winning opening 17 between a state at which it is easy to accept the gaming ball and a state at which it is difficult to accept the gaming ball, a special winning opening SOL (solenoid) 72S for opening and closing the door of the special winning opening 15 and a seesaw SOL (solenoid) 73S for driving a seesaw in the special winning opening 15.

When the respective sensors detect the gaming ball, a detection signal is inputted to the main CPU 201 of the main control circuit 200. Thereby, the main CPU 201 controls the driving of the actuators 71S, 72S, 73S in accordance with the inputted detection signal.

The control commands are transmitted to the sub-control circuit 300, the payout control circuit 70a and the shooting control circuit 70b from a command output port 206 of the main control circuit 200.

The sub-control circuit 300 having received the control command controls the operations of the liquid crystal display device 21, the speakers 8a, 8b and the lamp•LED 39a, and the payout control circuit 70a and the shooting control circuit 70b having received the control commands control the operations of a payout device 82 and the shooting device 90.

The payout control circuit 70a is connected to the payout device 82 for paying out an award ball or lending ball. The payout control circuit 70a controls the driving of the payout device 82 and pays out a predetermined number of gaming balls as an award ball, in accordance with the payout command signal outputted from the main control circuit 200, on condition that the gaming ball is accepted in the regular winning opening 12 and the special winning opening 15. In addition, the payout control circuit 70a controls the driving of the payout device 82 and pays out a predetermined number of gaming balls as a lending ball, in accordance with a lending command signal outputted from the card unit 81.

The shooting control circuit 70b is connected to the shooting device 90 for shooting the gaming ball toward the game area 2b. In addition, the shooting control circuit 70b controls the driving of the shooting solenoid to shoot the gaming ball from the shooting device 90, in accordance with the rotating operation of the handle 7.

In the followings, it is described a structure of the sub-control circuit 300. The sub-control circuit 300 is provided with a sub-CPU 301, a program ROM 302, a work RAM 303, a command input port 304, an image control circuit 305, a sound control circuit 306, a lamp control circuit 307 and an I/O port 308.

The sub-CPU 301 analyzes the command which is received from the main control circuit 200 via the command input port 304 and controls the image control circuit 305, the sound control circuit 306, the lamp control circuit 307 and the driving control circuit 309, based on the analysis result.

In addition, the sub-CPU 301 requests the IC chip reader 52 to read out the figure ID through the I/O port 308, based on the detection signal received from the photo sensor 59 and representing that the FIG. 50 is mounted to the base 50. Next, the sub-CPU 301 receives the figure ID from the IC chip reader 52 which has read out the figure ID from the IC chip 44 in accordance with the request.

In addition, the sub-CPU 301 analyzes the command which is received from the main control circuit 200 via the command input port 304 and controls the image control circuit 305, the sound control circuit 306 and the lamp control circuit 307, based on the analysis result. In addition, it controls the driving control circuit 309, based on the figure ID from the IC chip reader 52 which is received via the I/O port 308 as the analysis result.

The work RAM 303 serves as temporary memory means when the sub-CPU 301 carries out the process control in accordance with the control program and is allotted a receiving buffer area (not shown) for memorizing a command from the main CPU 201, an ID memory area (not shown) for memorizing a figure ID transmitted from the IC chip reader 52, a vibration pattern memory area (not shown) for memorizing a vibration pattern used to generate a driving signal and a work area (not shown) for memorizing the data necessary for the process control.

The program ROM 302 stores control programs (control data) for enabling the sub-CPU 301 to control the image control circuit 305, the sound control circuit 306, the lamp control circuit 307 and the driving control circuit 309 on the basis of the various commands outputted from the main control circuit 200.

When the sub-CPU 301 receives the variable display pattern command from the main control circuit 200, it sets the control data corresponding to the received command.

In addition, the sub-CPU 301 changes the data for instructing the image control circuit 305 to carry out a display of a special symbol or effect information image relating to the effect pattern included in the set control data, as time goes by.

The image control circuit 305 executes the instructions of the sub-CPU 301 which are transmitted every predetermined time period, so that the special symbol or effect information image corresponding to the variable display pattern is displayed in the display area 21a.

In addition, the program ROM 302 memorizes a plurality of pattern data (vibration patterns) relating to the vibrations of the vibration generating device 60.

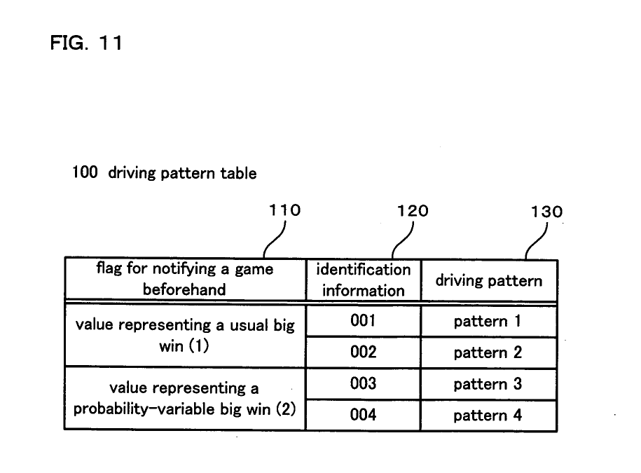

Specifically, the vibration pattern is memorized as a vibration pattern table 100 consisting of registration items 110, 120, 130 of the flag for notifying a game beforehand, the identification information and the vibration pattern, as shown in FIG. 11.

The registration item 110 of the flag for notifying a game beforehand is an item to be compared with the information of the flag for notifying a game beforehand, which is included in the variable display pattern command transmitted by the main CPU 201. In this item, it is memorized the information about the flag for notifying a game beforehand. For example, it is memorized the information corresponding to a case where the value (1) representing a usual big win is set in the flag for notifying a game beforehand and the information corresponding to a case where the value (2) representing a probability-variable big win is set in the flag for notifying a game beforehand.

The registration item 120 of the vibration pattern is an item to be compared with the figure ID (information) transmitted from the IC chip reader 52. In this item, it is memorized figure IDs (information) which are respectively provided to the plural detachable figures (decoration members) having types different from each other. The figure ID is provided with the same identification information with regard to the same type of decoration member (figure), as described above. For example, in the registration item 120, ┌001┘, ┌002┘, ┌003┘ and ┌004┘ represent “figure ID=001”, “figure ID=002”, “figure ID=003” and “figure ID=004”, respectively.

In the registration item 130 of the vibration pattern, it is memorized the flag for notifying a game beforehand and a vibration pattern corresponding to the figure ID (identification information). In the embodiment, in the registration item 130, it is memorized the pattern data for indicating (instructing) a pattern of vibration of the vibration generating device 60.

For example, a vibration pattern 1 includes the vibration pattern data for intermittently generating the vibration having a predetermined magnitude in the vibration generating device 60, a vibration pattern 2 includes the vibration pattern data for continuing the vibration having a predetermined magnitude for a predetermined time period in the vibration generating device 60, a vibration pattern 3 includes the vibration pattern data for generating intense vibration in the vibration generating device 60 and a vibration pattern 4 includes the vibration pattern data for generating slight vibration in the vibration generating device 60.

The sub-CPU 301 serves as a function of means for outputting a driving signal, thereby selecting a vibration pattern.

In the mean time, the means for outputting a driving signal is means for generating and outputting a driving signal for generating the vibration in the vibration generating device 60.

Specifically, it selects one vibration pattern, based on the information of the flag for notifying a game beforehand, which is included in the variable display pattern command transmitted from the main CPU 201, the figure ID transmitted from the IC chip reader 52 and the vibration pattern table 100.

For example, in case that the information of the flag for notifying a game beforehand, which is included in the variable display pattern command transmitted from the main CPU 201, is the value (1) representing a usual big win and the figure ID transmitted from the IC chip reader 52 is ┌001┘, the sub-CPU 301, which is means for outputting a driving signal, retrieves the vibration pattern table 100 and selects the ┌vibration pattern 1┘ corresponding to the value (1) representing a usual big win, figure ID ┌001┘.

The sub-CPU 301, which is means for outputting a driving signal, generates a driving signal for generating the vibration relating to the selected vibration pattern in the vibration generating device 60 and outputs the generated driving signal to the driving control circuit 309.

The driving control circuit 309 generates the vibration in the vibration generating device 60, based on the driving signal outputted from the sub-CPU 301, thereby driving the base 50.

In the mean time, the vibration generation of the vibration generating device 60 is carried out before the stop symbol is displayed in the special symbol display area.

As a consequence, it is possible to generate the vibration relating to the decoration member (figure 40) and to drive the base 60 as a preliminary notice (premonition) of the big win.

In the mean time, in case that the information of the flag for notifying a game beforehand, which is included in the variable display pattern command, is the value (1) representing a usual big win and the figure ID transmitted from the IC chip reader 52 is ┌004┘, there does not exist the identification information matched to the figure ID transmitted from the IC chip reader 52 in the identification information corresponding to a flag 1 for notifying a game beforehand, i.e., the identification information determined (sampled) from the vibration pattern table 100. Accordingly, the vibration pattern is not selected and the driving signal is also not outputted. As a result, the vibration generating device 60 is not vibrated and thus the base is not driven.

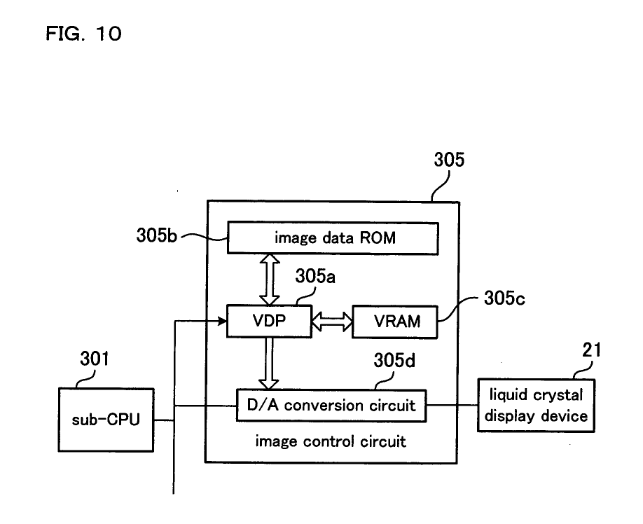

In the mean time, the image control circuit 305 shown in FIG. 9 carries out the display such as the variable display of the special symbol in the special symbol display area in accordance with the control of the sub-CPU 301 (control based on the control data which is set in a predetermined work area of the work RAM 303, correspondingly to the command received from the main control circuit 200), and comprises an image data ROM 305b memorizing the various image data, a VDP (Video Display Processor) 305a generating data for carrying out the display such as the variable display of the special symbol using the image data memorized in the image data ROM 305b under control of the sub-CPU 301 and a D/A conversion circuit 305d for converting the display image data generated by the VDP 305b into an analog signal, as shown in FIG. 10. In addition, the VDP 305a is connected to a VRAM 305c having two buffer areas provided thereto.

For example, the image control circuit 305 carries out an image display control process of variably displaying the special symbol and the effect information image (for example, character image) corresponding to the result of the big win determination with regard to the display area 21a, based on the control of the sub-CPU 301. In other words, the image control circuit 305 carries out the instructions from the sub-CPU 301 transmitted every predetermined time period, so that the special symbol or effect information image corresponding to the variable display pattern is displayed in the display area 21a, for example.

In addition, the image control circuit 305 and the display area 21a constitute means for notifying whether or not there occurs a ready-to win effect in a corresponding game, a type of a ready-to-win effect occurring or a reliability of a big win occurrence.

The VDP 305a carries out following processes, when generating the data for carrying out the display of the display area 21a based on the instructions transmitted from the sub-CPU 301 every predetermined time period (for example, 1/30 second). The VDP 305a reads out the predetermined image data from the image data ROM 305b, and develops the read data in the VRAM 305c while reading out the developed image data from the VRAM 305c. Specifically, the VDP 305a carries out the development process with regard to the one buffer area provided to the VRAM 305c and reads out the image data which has been already developed from the other buffer area. The VDP 305a changes the buffer area of the development process object and the buffer area of the reading object, based on the instruction of the sub-CPU 301. The VDP 305a displays the read image data to the display area 21a through the D/A conversion circuit 305d.

In addition, in the embodiment, the VRAM is used as a memory device for developing the image data. However, the invention is not limited thereto and the other memory devices may be used. For example, a SDRAM capable of reading and writing the data at high speed may be used.

The image data ROM 305b memorizes the special symbol image data for variably displaying the special symbol, which is an identification image, in the special symbol display area, the effect information image data for displaying the effect information image (effect information image including the character image) in the display area 21a, the demo effect image data for displaying a demonstration effect (hereinafter, referred to as ┌demo effect┘) and the game information image data for displaying the respective game information. The respective image data includes plural picture element data (data in a dot unit) which are required to display the respective image data in the display area 21a.

Again referring to FIG. 9, the sound control circuit 306 is connected to the speakers 8a, 8b. The sound control circuit 306 generates a sound signal, based on the control of the sub-CPU 301. The speakers 8a, 8b generate the sound, based on the sound signal inputted.

The lamp control circuit 307 is connected to the lamp-LED 39a. The lamp control circuit 307 generates a signal, based on the control of the sub-CPU 301. The lamp•LED 39a carries out the lighting-up display of the lamp or LED (for example, ordinary symbol memory LED or special symbol memory LED) provided to various places of the pachinko gaming machine 1, based on the signal inputted.

The speakers 8a, 8b, the lamp•LED 39a and the liquid crystal display device 21 serve as the effect means for carrying out an effect on the basis of the control data set by the sub-CPU 301.

The I/O port 308 is connected to an output of the photo sensor 59 and the IC chip reader 52 which are mounted to the base 50.

The output of the photo sensor 59 outputs a detection signal representing whether or not the figure 40 is mounted to the base 50. The detection signal is inputted to the sub-CPU 301 via the I/O port 308.

The IC chip reader 52 outputs the figure ID (figure ID of the figure 40 mounted to the base 50) read out in accordance with the request from the sub-CPU 301.

Specifically, the IC chip reader 52 reads out the figure ID memorized in the IC chip 44 of the figure 40 when there is the request for the reading of the figure ID from the sub-CPU 301, and inputs the read figure ID to the sub-CPU 301 via the I/O port 308.

The driving control circuit 308 is connected to the vibration generating device 60. The driving control circuit 308 controls the vibration generating device 60 so as to generate the vibration based on the driving signal outputted from the sub-CPU 301. Then, the vibration generating device 60 generates the vibration under control of the driving control circuit 309.

In addition, the respective processes of the pachinko gaming machine 1 are controlled by the main control circuit 200 and the sub-control circuit 300. The main control circuit 200 may process the entire or part of the processes controlled by the sub-control circuit 300. Likewise, the sub-control circuit 300 may process the entire or part of the processes controlled by the main control circuit 200.

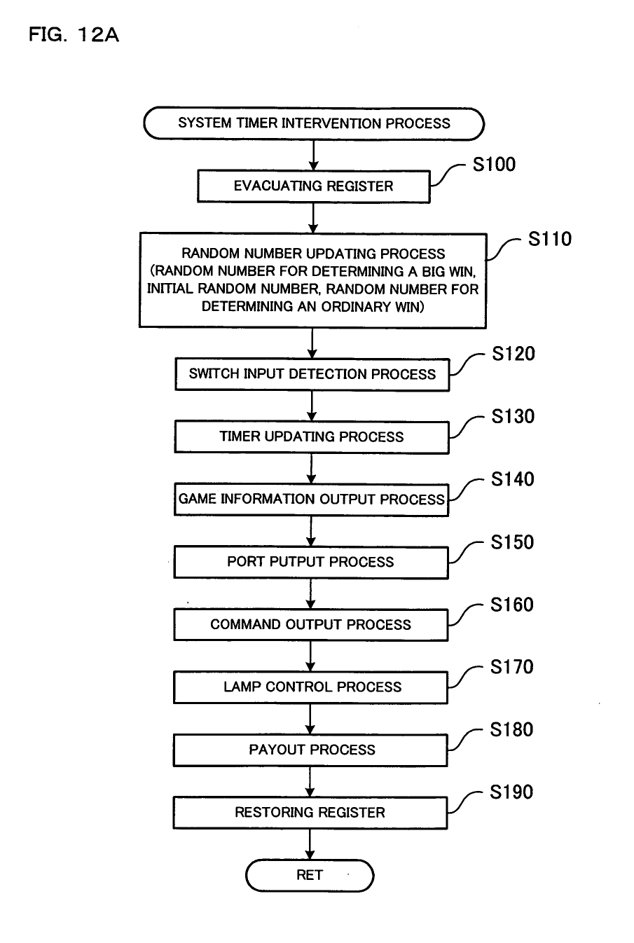

In the followings, it is described a process of the main control circuit 200 of the pachinko gaming machine 1, with reference to FIG. 12.

In the mean time, FIG. 12A is a flow chart showing a system timer intervention process which is carried out to intervene in a main process in a predetermined period (for example, 2 msec), and FIG. 12B is a flow chart showing a main process of the pachinko gaming machine 1 according to an embodiment of the invention.

First, it is described a system timer intervention process, with reference to FIG. 12A.

In a step S100, the main CPU 201 evacuates the information stored in a register.

In a step S110, the main CPU 201 updates the random number value for determining a big win, the random number value for determining an ordinary win and the like.

In a step S120, the main CPU 201 carries out a switch input detecting process. In the followings, it is specifically described the switch input detecting process.

The main CPU 201 detects the detection signals outputted from the start opening SW 19a, the regular winning opening SW 19Sb, the V•count SW 19Sd, the count SW 19Se and the passage gate SW 19Sa, through the I/O port 205. The main CPU 201 having detected the signals carries out the following (1)˜(5) processes, depending on the contents of the detection signals detected.

(1) When the main CPU 201 detects the detection signal from the count SW 19Se through the I/O port 205, it counts the number of gaming balls accepted in the special winning opening 15 during one time round in the big win gaming state and updates the special winning opening-winning counter. In the mean time, as described above, the one time round is a period from after the door of the special winning opening 15 is opened until a predetermined time period (for example, 29.5 seconds) elapses, or from after the door of the special winning opening 15 is opened until the predetermined number of gaming balls (for example, 10 balls) is accepted in the special winning opening 15.

(2) When the main CPU 201 detects the detection signal from the V•count SW 19Sd through the I/O port 205, it detects that the gaming ball has passed to the big win area during one time round in the big win gaming state, at the same time, counts the number of gaming balls accepted in the special winning opening 15 and updates the special winning opening-winning counter.

(3) When the main CPU 201 detects the detection signal from the start opening SW 19a provided to the start winning openings 14, 17 through the I/O port 205, it checks the value of the winning memory counter. When the value is 4 or less, it samples a random number value for determining a big win and a random number value for determining a big win symbol by the random number lottery and memorizes them in winning memory areas of the main RAM 203, as the winning memory.

In the mean time, when the value of the winning memory counter is 0, the special symbol is not variably displayed and the winning memory-number is 0. When the value of the winning memory counter is 1, the special symbol is variably displayed and the winning memory-number is 0. In addition, when the value of the winning memory counter is 5, the special symbol is variably displayed and it is displayed in the special symbol memory LED that the number of winning memory is 4.

(4) When the main CPU 201 detects the detection signal from the passage gate SW 19Sa provided to the passage gate 13 through the I/O port 205, it checks the value of the passing memory counter. When the value is 4 or less, it samples a random number value for determining an ordinary win by the random number lottery and memorizes it in a passing memory area of the main RAM 203, as the passing memory.

In addition, when it is under state that the ordinary symbol cannot be variably displayed in the ordinary symbol display area (for example, the symbol is variably displayed in the ordinary symbol display area, based on a result of the other ordinary win determination), the main CPU 201 outputs to the sub-control circuit 300 a control command to instruct the ordinary symbol display LED to display that there exists the passing memory, until it is possible to variably display the symbol in the ordinary symbol display area.

In the mean time, when the value of the passing memory counter is 0, the ordinary symbol is not variably displayed in the ordinary symbol display area and the passing memory-number is 0. When the value of the passing memory counter is 1, the ordinary symbol is variably displayed in the ordinary symbol display area and the passing memory-number is 0. In addition, when the value of the passing memory counter is 5, the ordinary symbol is variably displayed and it is displayed in the ordinary symbol memory LED that the passing memory-number is 4.

(5) When the main CPU 201 detects the detection signal from the passage gate SW 19Sa through the I/O port 205, it carries out the ordinary win determination, based on the random number value for determining an ordinary win sampled by the random number lottery and the ordinary win determining table, and outputs to the sub control circuit 300 a control command to variably display the symbol in the ordinary symbol display area on the basis of the result of the ordinary win determination.

In a step S130, the main CPU 201 updates the remaining variable display time of the ordinary symbol or special symbol variably displayed, the remaining display time of the effect information image displayed, the remaining open time of the start winning opening 17 or the special winning opening 15 under state that it is easy to accept the gaming ball, and the like.

In a step S140, the main CPU 201 outputs the game information, such as the number of gaming balls paid out as an award ball and the occurrence of the big win, to a hall computer which is equipped in a game arcade.

In a step S150, the main CPU 201 controls the driving of the solenoids, such as the movable member SOL 71S, the special winning opening SOL 72S, the seesaw SOL 73S and the like.

In a step S160, the main CPU 201 outputs a command to instruct a stop symbol of the special symbol, a variable display pattern command and the other commands to the sub-control circuit 300.

In a step S170, the main CPU 201 outputs a control command to instruct the sub-control circuit 300 to display the winning memory-number of the start winning openings 14, 17, which is memorized in the main RAM 203, in the predetermined area of the special symbol memory LED and outputs a control command to instruct the sub-control circuit 300 to display an error, such as the exhaustion of the gaming ball and the full of the lower tray, in the predetermined lamp.

In a step S180, the main CPU 201 outputs a control command such as a payout command signal to instruct the payout control circuit 70a to pay out the predetermined number of gaming balls as an award ball in accordance with the type (for example, regular winning opening 12 or special winning opening 15) of the winning opening in which the gaming ball is accepted.

In a step S190, the main CPU 201 restores the information evacuated in the step S100 to the register.

In the followings, it is described a main process of the main control circuit 200, with reference to FIG. 12B.

In a step S10, the main CPU 201 restores or initializes the various settings of the pachinko gaming machine 1 to the setting contents at the time when the previous power is formerly cut off.

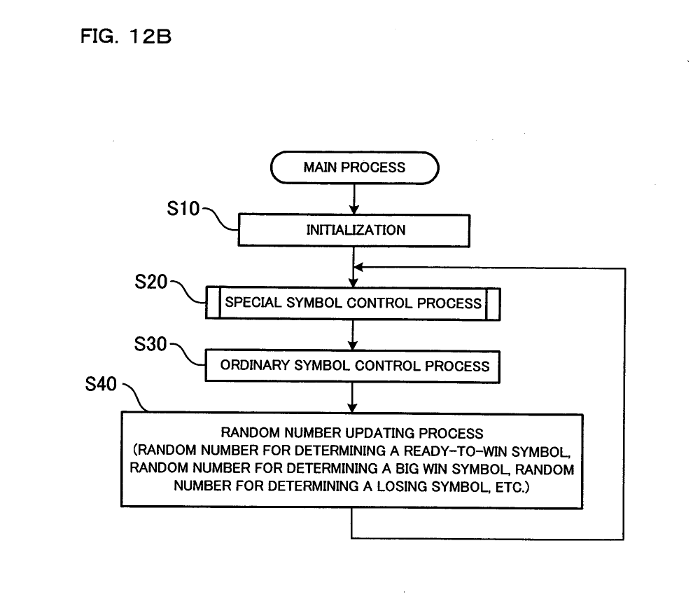

In a step S20, the main CPU 201 carries out a special symbol control process (see FIG. 13) which will be described later.

In a step S30, the main CPU 201 carries out the respective processes regarding the ordinary symbol. Specifically, the main CPU 201 carries out the ordinary win determination, based on the random number for determining an ordinary win which is sampled on condition that the gaming ball passes to the passage gate 13. Then, the main CPU generates and sets a command to instruct the variable display of the ordinary symbol in the ordinary symbol display area, based on a result of the ordinary win determination. After that, the main CPU 201 subtracts ┌1┘ from the passing memory counter and shifts the data memorized in the respective passing symbol memory areas (┌1┘˜┌4┘) to the ordinary symbol memory areas (┌0┘˜┌3┘), respectively.

In the mean time, the ordinary symbol memory area is a passing memory area which is allotted to the main RAM 203 and in which the random number for determining an ordinary win sampled on condition that the gaming ball passes to the passage gate 13 is sequentially memorized from the passing symbol memory area ┌0┘. In addition, the random number for determining an ordinary win and the like memorized in the ordinary symbol memory areas (┌1┘˜┌4┘) correspond to the passing memory, and the random number for determining an ordinary win, etc. memorized in the ordinary symbol memory area ┌0┘, are used for the ordinary win determination.

In a step S40, the main CPU 201 updates the values of the random number for determining a ready-to-win symbol, the random number for determining a big win symbol, the random number for determining a losing symbol, and the like.

In the mean time, the main CPU 201 repetitively carries out the processes from the step S20 to the step S40.

In the followings, it is described the special symbol control process in the step S20, with reference to FIG. 13. In the mean time, FIG. 13 is a flow chart showing a special symbol control process.

In a step S20-1, the main CPU 201 carries out a process of loading a control state flag. In the mean time, the control state flag is a flag representing a gaming state of the special symbol game. The main CPU 201 determines whether or not to carry out each process in steps S20-2 to S20-10, based on the control state flag.

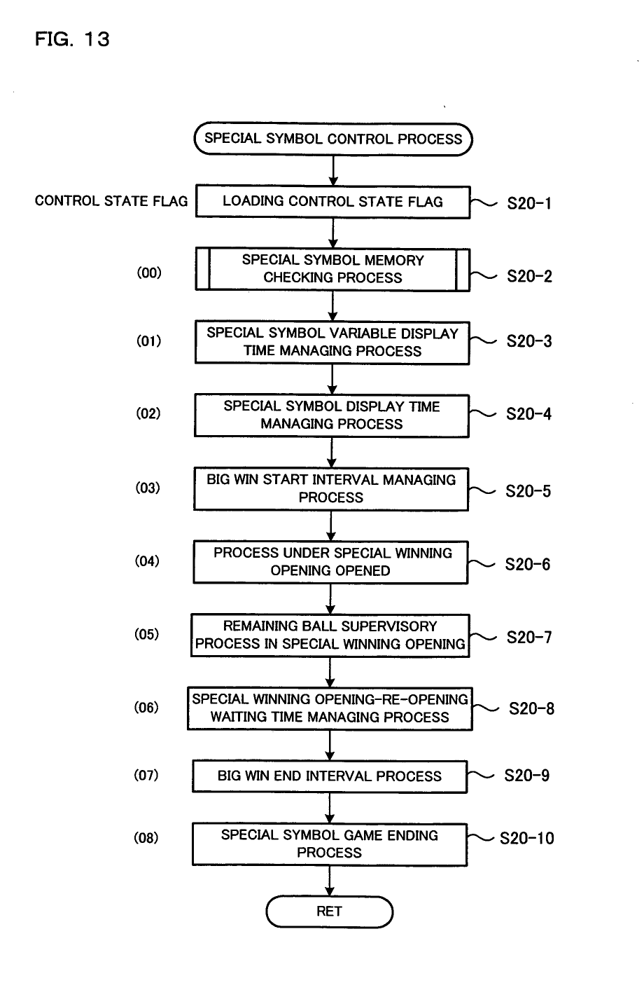

In a step S20-2, the main CPU 201 carries out a special symbol memory checking process (see FIG. 14) which will be specifically described. Herein, it is mainly carried out a big win determining process. Then, it is carried out a determination of a symbol and a determination of a variable display pattern in accordance with a result of the determination.

In a step S20-3, in case that the control state flag is a value (01) representing a special symbol variable display time management and a value of the waiting time timer having the variable display time set thereto is ┌0┘, the main CPU 201 sets a value (02) representing a special symbol display time managing process to the control state flag and sets the waiting time after a decision (for example, 1 second) to the waiting time timer.

In a step S204, in case that the control state flag is a value (02) representing a special symbol display time managing process, a value of the waiting time timer having the waiting time after a decision set thereto is ┌0┘ and a result of the big win determining process in the special symbol checking process of the step S20-2 causes the gaming state to be shifted to the big win gaming state, the main CPU 201 sets a value (03) representing a big win start interval managing process to the control state flag and sets a time period (for example, 10 seconds) corresponding to a big win start interval to the waiting time timer. Herein, the main CPU 201 sets a value ┌2┘ representing the big win gaming state to a gaming state check flag. Then, it generates and sets a big win game start command. In the mean time, the big win gaming state start command includes the information of the gaming state check flag.

In addition, in case that a result of the big win determining process in the special symbol checking process does not cause the gaming state to be shifted to the big win gaming state (i.e., in case of the losing), the main CPU 201 sets a value (08) representing a special symbol game ending process to the control state flag.

Herein, when the value (08) representing a special symbol game ending process is set to the control state flag, the main CPU 201 determines whether or not it is fulfilled a predetermined probability-variable condition. As a result of the determination, when it is determined that the predetermined probability-variable condition is fulfilled, the main CPU sets a value (77) representing a check on probability-variable to a high probability flag and sets a value ┌1┘, representing the special gaming state to the gaming state check flag.

In the mean time, when it is determined that the predetermined probability-variable condition is not fulfilled, the main CPU sets a value (00) representing a usual check to the high probability flag and sets the value ┌0┘ representing the base gaming state to the gaming state check flag.

In the mean time, the high probability flag is a flag for determining whether or not a gaming state is the special gaming state. When the high probability flag is a value (77) representing the check on probability-variable, it is meant that a gaming state is the special gaming state. When the high probability flag is a value (00) representing the usual check, it is meant that a gaming state is not the special gaming state.

In a step S20-5, in case that the control state flag is the value (03) representing a big win start interval managing process and the value of the waiting time timer having the time period corresponding to the big win start interval set thereto is ┌0┘, the main CPU 201 controls the special winning opening SOL 72S to open the door of the special winning opening 15. The main CPU 201 sets a value (04) representing a process under special winning opening opened to the control state flag and sets the upper limit of open time (for example, 30 seconds) to a special winning opening-open time timer.

In a step S20-6, in case that the control state flag is the value (04) representing a process under special winning opening opened, the main CPU 201 checks whether it is fulfilled a condition that the value of the special winning opening-open time timer having the upper limit of open time set thereto is ┌0┘ or a condition that ten or more gaming balls are accepted in the special winning opening 15. Herein, when one of the two conditions is satisfied, the main CPU 201 controls the special winning opening SOL 72S to close the door of the special winning opening 15, sets a value (05) representing a remaining ball supervisory process in a special winning opening to the control state flag and sets a time period for supervising a remaining ball in a special winning opening (for example, 1 second) to the waiting time timer.

In a step S20-7, in case that the control state flag is the value (05) representing a remaining opening supervisory process in a special winning opening and the value of the waiting time timer, to which the time period for supervising a remaining opening in a special winning opening is set, is ┌0┘, the main CPU 201 checks whether it is satisfied a condition that a gaming ball has not passed to the big win area of the special winning opening 15 or a condition that the counter for counting the number of cases where a special winning opening is opened is ┌15┘ or more (i.e., final round). In the mean time, the counter for counting the number of cases where a special winning opening is opened is provided to count the number of rounds in the big win gaming state.

In addition, when one of the two conditions is satisfied in the step S20-7, the main CPU 201 sets a value (07) representing a big win end interval process to the control state flag and sets a time period corresponding to the big win end interval to the waiting time timer. In addition, when any of the conditions is not fulfilled in the step S20-7, the main CPU 66 sets a value (06) representing a special winning opening-re-opening waiting time managing process to the control state flag and sets a time period corresponding to the interval between the rounds to the waiting time timer.

In a step S20-8, in case that the control state flag is the value (06) representing a special winning opening-re-opening waiting time managing process and the value of the waiting time timer, to which the time period corresponding to the interval between the rounds is set, is ┌0┘ the main CPU 201 adds ┌1┘ to the counter for counting the number of cases where a special winning opening is opened. In addition, the main CPU 201 sets the value (04) representing a process under special winning opening opened to the control state flag and sets the upper limit of open time (for example, 30 seconds) to the special winning opening-open time timer.

In a step S20-9, in case that the control state flag is the value (07) representing a big win end interval process and the value of the waiting time timer, to which the time period corresponding to the big win end interval is set, is ┌0┘, the main CPU 201 sets a value (08) representing a special symbol game ending process to the control state flag. In addition, the main CPU 201 generates and sets a big win game ending command. In the mean time, the special game ending command includes the information of the gaming state check flag.

In addition, the main CPU 201 checks whether or not the stop symbol representing a big win is a specific symbol such as ┌7┘ or ┌3┘, i.e., whether or not a predetermined probability-variable condition is fulfilled.

Herein, when it is checked that a predetermined probability-variable condition is fulfilled, the main CPU 301 sets the value (77) representing the check on probability-variable to the high probability flag and sets the value ┌1┘ representing the special gaming state to the gaming state check flag. In the mean time, when it is checked that a predetermined probability-variable condition is not fulfilled, the main CPU 301 sets the value (00) representing the usual check to the high probability flag and sets the value ┌0┘ representing the base gaming state to the gaming state check flag.

In a step S20-10, in case that the control state flag is a value (08) representing a special symbol game ending process, the main CPU 201 subtracts ┌1┘ from the winning memory counter. In addition, the main CPU 201 shifts the data memorized in the respective special symbol memory areas (┌1┘˜┌4┘) to the special symbol memory areas (┌0┘˜┌3┘), respectively, and sets the value (00) representing the special symbol memory checking process to the control state flag.

In the mean time, the special symbol memory area is a winning memory area which is allotted to the main RAM 203 and in which the random number for determining a big win sampled on condition that a winning of the gaming ball is made in the start winning openings 14, 17 is sequentially memorized from the special symbol memory area ┌0┘. In addition, the random number for determining a big win and the like memorized in the special symbol memory areas (┌1┘˜┌4┘) correspond to the winning memory and the random number for determining a big win, etc. memorized in the special symbol memory area ┌0┘ are used for the big win determination in a step S20-2-5.

In the followings, it is described the special symbol memory checking process in the step S20-2, with reference to FIG. 14. In the mean time, FIG. 14 is a flow chart showing a special symbol memory checking process.

In a step S20-2-1, the main CPU 201 checks whether the control state flag is the value (00) representing the special symbol memory check. As a result of the check, when it is determined that the control state flag is the value (00) representing the special symbol memory check, the main CPU 201 proceeds to a step S20-2-2. In the mean time, when it is determined that the control state flag is not the value (00) representing the special symbol memory check, the main CPU 201 ends the special symbol memory checking process.

In a step S20-2-2, the main CPU 201 checks whether or not the winning memory-number is ┌0┘. When it is determined that the winning memory-number is ┌0┘, the main CPU 201 proceeds to a step S20-2-3, otherwise proceeds to a step S20-24.

In a step S20-2-3, the main CPU 201 sets a value ┌3┘ representing a customer-standing by state to the gaming state check flag. Then, the main CPU generates and sets a demo effect command to instruct the display of the demo effect image to be executed. In the mean time, the demo effect command includes the information of the gaming state check flag. In addition, the demo effect command is generated when the gaming state is the customer-standing by state (the state that the variable display of the special symbol is not carried out, it is not the big win gaming state and there is no winning memory).

In a step S20-24, the main CPU 201 sets the value (01) representing a special symbol variable display time management to the control state flag.

In a step S20-2-5, the main CPU 201 carries out a big win determination, based on the random number value for determining a big win included in the winning memory.

In a step S20-2-6, the main CPU 201 checks whether or not the result of the big win determination causes the gaming state to be shifted to the big win gaming state (i.e., whether it is made a big win). As a result, when it is determined that the result of the big win determination causes the gaming state to be shifted to the big win gaming state, the main CPU 201 proceeds to a step S20-2-8. In the mean time, when it is determined that the result of the big win determination does not cause the gaming state to be shifted to the big win gaming state, the main CPU 201 proceeds to a step S20-2-7.

In a step S20-2-7, the main CPU 201 determines a stop symbol representing the losing, based on a predetermined random number value.

Specifically, the main CPU 201 determines whether or not to carry out a ready-to-win (ready-to-win variable display) in the variable display of the special symbol, based on a random number value sampled from the random numbers for determining a ready-to-win. As a result of the determination, when it is determined that a ready-to-win (ready-to-win variable display) is carried out in the variable display of the special symbol, the main CPU determines the ┌left┘ and ┌right┘ symbols, based on the random number value sampled from the random numbers for determining a ready-to-win, and determines the ┌center┘ symbol, based on the random number value sampled from the random numbers for determining a center losing symbol.

In the mean time, the main CPU 201 having determined not to carry out the ready-to-win in the variable display of the special symbol determines the ┌left┘, ┌center┘ and ┌right┘ symbols, based on the random number values sampled from the random numbers for determining a losing symbol corresponding to the ┌left┘, ┌center┘ and ┌right┘. Then, based on the determination, the main CPU generates and sets a stop symbol command. In the mean time, the stop symbol command includes the information of the gaming state check flag.

In a step S20-2-8, the main CPU 201 determines the stop symbols (┌left┘, ┌center┘ and ┌right┘) representing the big win, based on the random number value for determining a big win symbol included in the winning memory. Then, based on the determination, the main CPU generates and sets the stop symbol command. In the mean time, the stop symbol command includes the information of the gaming state check flag.

In a step S20-2-9, the main CPU 201 carries out a process of updating the flag for notifying a game beforehand.

Specifically, in case that a stop symbol representing a big win, which is determined in the step S20-2-8, is the non-special display mode (usual big win symbol) which is a display mode representing a usual big win, the main CPU sets a value (01) representing a usual big win to the flag for notifying a game beforehand. In the mean time, in case that a stop symbol representing a big win, which is determined in the step S20-2-8, is the special display mode (probability-variable big win symbol) which is a display mode representing a probability-variable big win, the main CPU sets a value (07) representing a probability-variable big win to the flag for notifying a game beforehand.

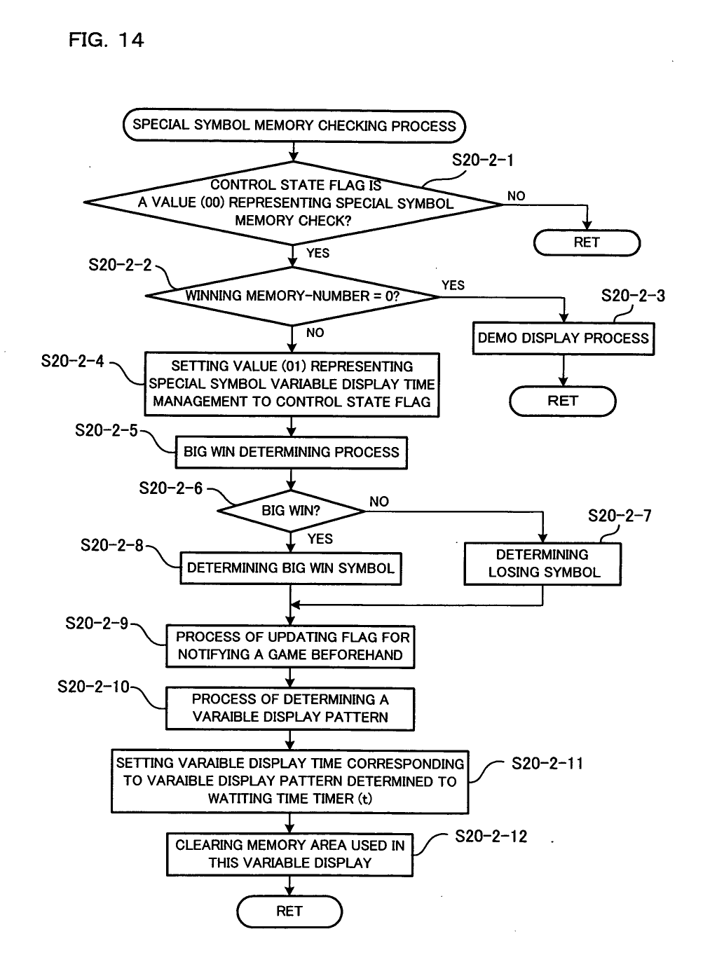

In a step S20-2-10, the main CPU carries out a process of determining a variable display pattern of the special symbol. Specifically, the main CPU 201 samples one of the random numbers which are generated in a range of 0 to 99 by the random number generator. Then, the main CPU 201 compares the sampled random number value with the variable display pattern selecting table shown in FIG. 15 to determine a variable display pattern of the special symbol. Then, based on the determination, the main CPU generates and sets a variable display pattern command including the information of the flag for notifying a game beforehand.

For example, in case that a result of the big win determination does not cause the gaming state to be shifted to the big win gaming state and it is not carried out the ready-to-win in the variable display of the special symbol, the main CPU 201 determines a ┌usual variation┘ as the variable display pattern of the special symbol and at the same time generates and sets a variable display pattern command, based on the determination. In the mean time, the variable display pattern command includes the information of the gaming state check flag.

In addition, in case that a result of the big win determination does not cause the gaming state to be shifted to the big win gaming state and the random number value sampled when it is carried out the ready-to-win in the variable display of the special symbol is within a range of 0 to 69, the main CPU 201 determines a ┌normal ready-to-win┘ as the variable display pattern of the special symbol. In the mean time, in case that the sampled random number value is within a range of 70 to 99, it determines a ┌super ready-to-win┘ as the variable display pattern of the special symbol.

Further, in case that a result of the big win determination causes the gaming state to be shifted to the big win gaming state, when the sampled random number value is within a range of 0 to 39, the main CPU 201 determines a ┌Winning of a normal ready-to-win┘ as the variable display pattern of the special symbol. When the sampled random number value is within a range of 40 to 94, the main CPU 201 determines a ┌Winning of a super ready-to-win┘ as the variable display pattern of the special symbol. In addition, when the sampled random number value is within a range of 95 to 99, the main CPU 201 determines an ┌entire rotation┘ as the variable display pattern of the special symbol. Then, the main CPU generates and sets a variable display pattern command, based on the corresponding determination. In the mean time, the variable display pattern command includes the information of the gaming state check flag.

In a step S20-2-11, the main CPU 201 sets the variable display time corresponding to the variable display patterns determined in the step S20-2-10 to the waiting time timer.

In the mean time, the variable display of the special symbol is carried out during the variable display time determined in the step S20-2-11, based on the variable display pattern determined in the step S20-2-10. When the variable display time is over, the special symbol being variably displayed is stopped under state that the symbol depending on the stop symbol command is displayed.

In a step S20-2-12, the main CPU 201 erases the random number value and the like, which are used in this special symbol memory checking process, from the predetermined memory areas, clears the flag for notifying a game beforehand and sets the value (0) to the corresponding flag.

In the mean time, the main CPU 201 carries out a process of determining a display pattern (effect information display pattern) of the effect information image through a lottery, in addition to the respective processes of the special symbol or ordinary symbol.

Specifically, the main CPU 201 samples one of the random numbers which are generated in a range of 0 to 1999 by the random number generator. Then, the main CPU 201 compares the sampled random number value with an effect information image display pattern determining table preset and determines a display pattern of the effect information image. Then, the main CPU enables the effect image display pattern data representing the effect image display pattern to be included in the variable display pattern command.

In other words, the variable display pattern command includes the special symbol display pattern data representing the special symbol display pattern, the effect information image display pattern data representing the effect information image display pattern, the information of the flag for notifying a game beforehand, etc.

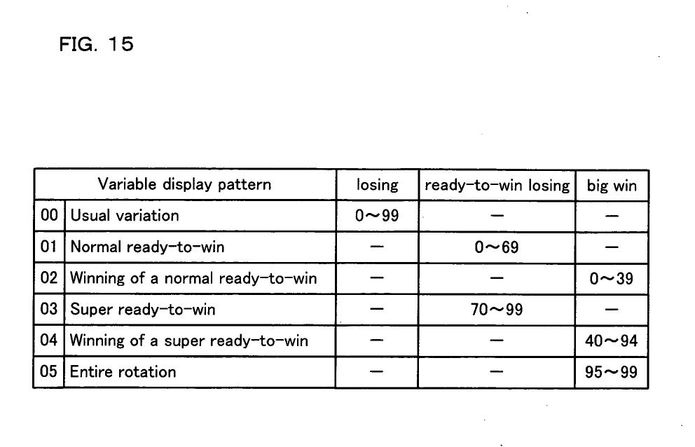

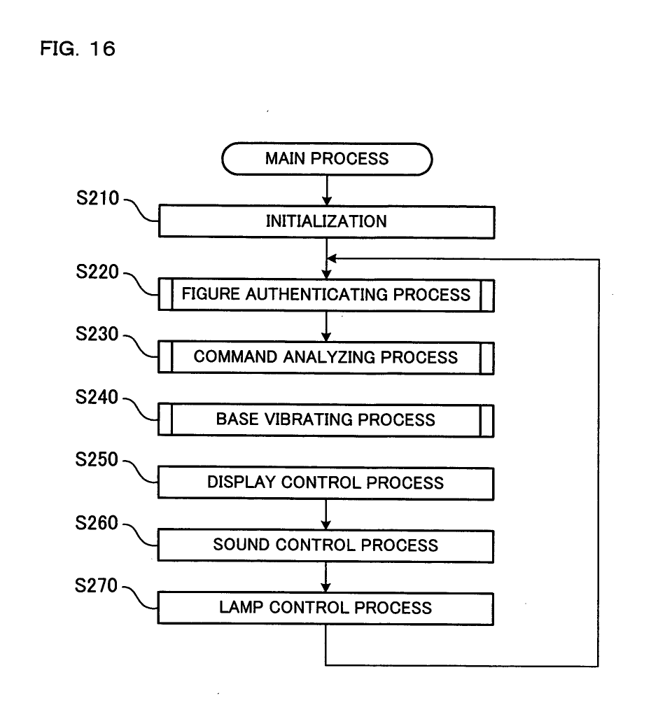

In the followings, it is described a main process of the sub-control circuit 300 and a command receiving intervention process which is carried out to intervene in the main process when a command is received from the main control circuit 200. FIG. 16 is a flow chart showing the main process and FIG. 17 is a flow chart showing a command receiving intervention process.

First, it is described a command receiving intervention process with reference to FIG. 17. The command receiving intervention is adapted to occur whenever the sub-control circuit 300 receives a command from the main control circuit 200.

In a step S201, the sub-CPU 301 evacuates the information stored in the register so as to interrupt a process (main process) being currently carried out.

In a step S202, the sub-CPU 301 stores the command (for example, variable display pattern command) received from the main control circuit 200 via the command input port 304 in the receiving buffer area of the work RAM 303.

In a step S203, the sub-CPU 301 restores the information evacuated in the step S201 to the register. Thereby, the process interrupted can be resumed.

In the followings, it is described a main process of the sub-control circuit 300 with reference to FIG. 16.

In steps S210˜S230, the sub-CPU 301 carries out an initialization process of initializing the various settings, then a figure authenticating process and a command analyzing process.

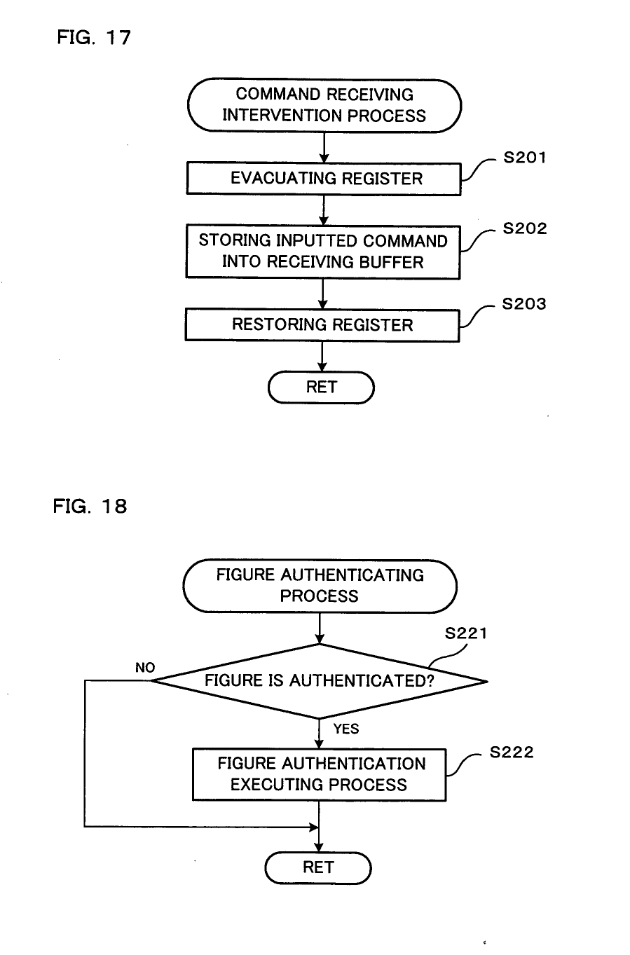

Herein, it is described the figure authenticating process in a step S220 with reference to FIG. 18. FIG. 18 is a flow chart showing the figure authenticating process.

In a step S221, the sub-CPU 301 determines whether or not a figure authentication is made (whether or not the figure 40 is mounted to the base 50), based on a detection signal from the output of the photo sensor 59, which is received via the I/O port 308.

When it is determined in the step S221 that a figure is authenticated because the detection signal is a signal representing that the figure 40 is mounted to the base 50, the sub-CPU 301 proceeds to a step S222. In the mean time, when it is determined that a figure is not authenticated because the detection signal is a signal representing that the figure 40 is not mounted to the base 50, the sub-CPU 301 ends the figure authenticating process.

In a step S222, the sub-CPU 301 carries out a figure authentication executing process. In the figure authentication executing process, the sub-CPU 301 initializes the contents (figure ID) of the ID memory area in the work RAM 303, requests the IC chip reader 52 to read out the figure ID through the I/O port 308, receives the figure ID from the IC chip reader 52 having read out the corresponding figure ID from the IC chip 44 in response to the request through the I/O port 308, and stores the figure ID in the ID memory area of the work RAM 303.

In the mean time, when it is determined that a figure authentication is not made, nothing is stored in the ID memory area.

In the embodiment, the initialization of the contents (figure ID) of the ID memory area is carried out in the figure authentication executing process. However, it may be carried out when a gamin is over, irrespective of whether a game is started with the figure 40 being mounted to the base 50.

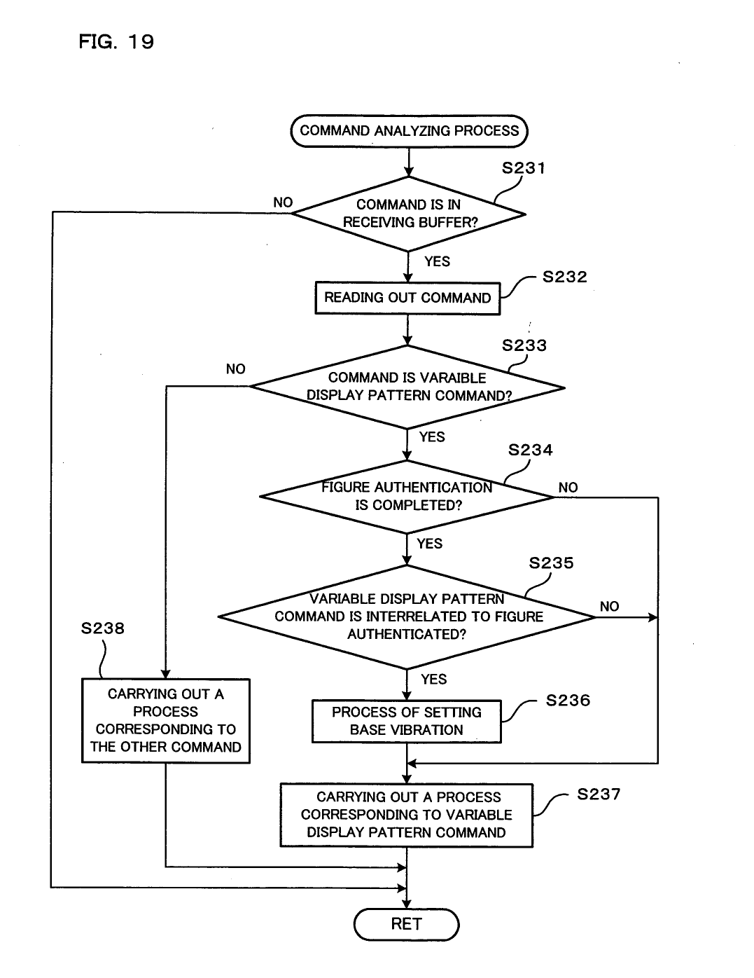

In the followings, it is described a command analyzing process in a step S230, with reference to FIG. 19. FIG. 19 is a flow chart showing the command analyzing process.

In a step S231, the sub-CPU 301 determines whether a command is memorized in the receiving buffer. When it is determined that the command is memorized in the receiving buffer, the sub-CPU proceeds to a step S232. When it is determined that the command is not memorized in the receiving buffer, the sub-CPU ends the command analyzing process.

In a step S232, the sub-CPU 301 reads out the command from the receiving buffer.

In a step S233, the sub-CPU 301 determines whether the read command is the variable display pattern command. When it is determined that the read command is the variable display pattern command, the sub-CPU proceeds to a step S234. In the mean time, when it is determined that the read command is not the variable display pattern command (i.e., it is the other commands), the sub-CPU proceeds to a step S237.

In a step S234, the sub-CPU 301 determines whether a figure authentication is completed, based on whether the figure ID is memorized in the ID memory area of the work RAM 303. At this time, when the figure ID is memorized in the ID memory area, it is determined that the figure authentication is completed (i.e., the figure 40 is mounted to the base 50). When the figure ID is not memorized in the ID memory area, it is determined that the figure is not authenticated (i.e., the figure 40 is not mounted to the base 50).

When it is determined that the figure authentication is completed, the sub-CPU 302 proceeds to a step S235. In the mean time, when it is determined that the figure is not authenticated, the sub-CPU proceeds to a step S236.

In the step S235, the sub-CPU 301 checks whether the variable display command read out in the step S232 is interrelated to the figure ID (figure ID memorized in the ID memory area of the work RAM 303) for which it is carried out the authentication in the step S234.

Specifically, the sub-CPU 301 checks whether the information of the flag for notifying a game beforehand is included in the variable display pattern command read out in the step S232. When it is determined that the information of the flag for notifying a game beforehand is not included, the sub-CPU proceeds to a step S237.

In the mean time, when it is determined that the information of the flag for notifying a game beforehand is included in the variable display pattern command, the sub-CPU determines (samples) the corresponding identification information, based on the information of the corresponding flag for notifying a game beforehand, with reference to the vibration pattern table shown in FIG. 11, and checks whether or not there exists the identification information matched to the figure ID for which it is carried out the authentication in the step S234 in the determined identification information.

When it is determined that there exists the identification information matched to the figure ID, for which it is carried out the authentication in the step S234, in the identification information which is determined on the basis of the information of the flag for notifying a game beforehand, the sub-CPU proceeds to a step S236. In the mean time, when it is determined that there does not exist the identification information matched to the figure ID, for which it is carried out the authentication in the step S234, in the identification information which is determined on the basis of the information of the flag for notifying a game beforehand, the sub-CPU proceeds to a step S237.

In the step S236, the sub-CPU 301 carries out a process of setting a base vibration, based on the flag for notifying a game beforehand, which is included in the variable display pattern command, and the figure ID for which it is carried out the authentication in the step S234.

Specifically, the sub-CPU 301 selects a vibration pattern, based on the flag for notifying a game beforehand, which is included in the variable display pattern command received, the figure ID for which it is carried out the authentication in the step S234 and the vibration pattern table shown in FIG. 11, and stores the selected vibration pattern in the vibration pattern memory area.

In a step S237, the sub-CPU 301 carries out a predetermined process, based on the variable display pattern command.

In other words, the sub-CPU 301 sets the control data (control data corresponding to one pattern of the variable display patterns ┌00┘˜┌05┘ shown in FIG. 15) corresponding to the special symbol display pattern data included in the variable display pattern command received in the work area of the work RAM 303.

In a step S238, the sub-CPU 301 carries out a predetermined process, based on the received command.

In other words, the sub-CPU 301 sets the control data in which the received command corresponds to the command (for example, big win game start command to instruct a start of a big win gaming state) besides the variable display pattern command, in the work area of the work RAM 303.

Again referring to FIG. 16, in a step S240, the sub-CPU 301 carries out a base vibrating process.

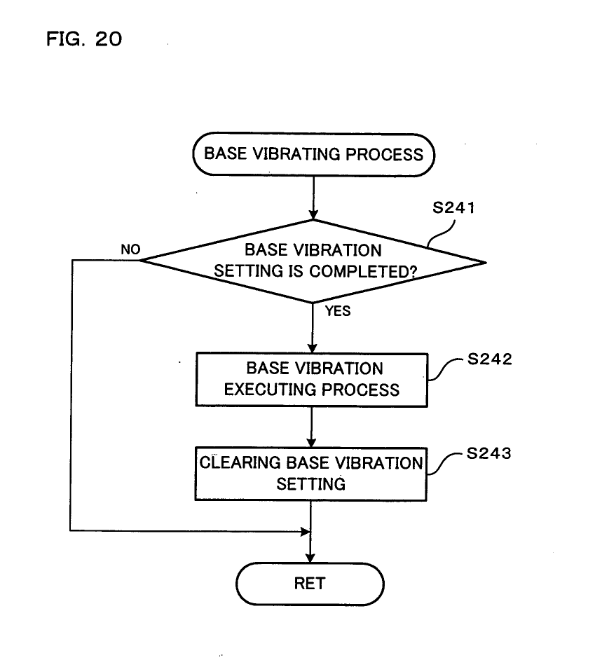

In the followings, it is described the base vibrating process with reference to FIG. 20. FIG. 20 is a flow chart showing the base vibrating process.

In a step S241, the sub-CPU 301 determines whether the vibration pattern is memorized in the vibration pattern memory area. When it is determined that the vibration pattern is memorized in the vibration pattern memory area, the sub-CPU 301 proceeds to a step S242. In the mean time, when it is determined that the vibration pattern is not memorized in the vibration pattern memory area, the sub-CPU 301 ends the base vibrating process.

In a step S242, the sub-CPU 301 carries out a process of carrying out a base vibration.

Specifically, the sub-CPU 301 generates a driving signal, based on the vibration pattern memorized in the vibration pattern memory area, and outputs the generated driving signal to the driving control circuit 309. The driving control circuit 309 having received the driving signal generates the vibration in the vibration generating device 60, based on the corresponding driving signal. In other words, the vibration generating device 60 generates the vibration, based on the vibration pattern memorized in the vibration pattern memory area, thereby driving the base 50.

In a step S243, the sub-CPU 301 erases the information stored in the vibration pattern memory area and the random number used for the process of carrying out a base vibration from the predetermined memory area.

Again referring to FIG. 16, in a step S250, the sub-CPU 301 checks the control data set in the step S237 (see FIG. 19). In case that the control data is the control program for controlling a process of the image control circuit 305, the sub-CPU carries out an image display control process, based on the corresponding control data.

For example, when the control data corresponding to the variable display pattern command is set in the step S237, the sub-CPU 301 changes the data for instructing the VDP 305a to variably display the special symbol relating to the variable display pattern included in the set control data, as time goes by. When the VDP 305a carries out the instructions transmitted every predetermined time, it is carried out the variable display of the special symbol corresponding to the variable display pattern command for the variable display time in the special symbol display area of the liquid crystal display device 21. When the variable display time is over, the special symbol displays and stops a symbol indicated by the stop symbol command.

In addition, the sub-CPU 301 changes the data for instructing the VDP 305a to display the effect information image relating to the effect pattern included in the set control data. When the VDP 305a carries out the instructions transmitted every predetermined time, it is carried out the display of the effect information image corresponding to the variable display pattern command in the display area 21a.

In a step S260, the sub-CPU 301 carries out a sound control process.

Specifically, in the sound control process, when the control data set in the step S238 (see FIG. 19) is the data corresponding to the sound control, the sub-CPU 301 transmits the control data to the sound control circuit 306. The sound control circuit 306 outputs to the speaker 11 a signal for notifying the player of a predetermined gaming state, based on the control data.

In a step S270, the sub-CPU 301 carries out a lamp•LED lighting-up control process.

In addition, in the lamp•LED lighting-up control process, when the control data set in the step S238 (see FIG. 19) is the data corresponding to the lamp or LED lighting-up control, the sub-CPU 301 transmits the control data to the lamp control circuit 307. The lamp control circuit 307 controls the lamp•LED 39a to carry out the lighting-up and lights-out in accordance with a predetermined lighting-up and lights-out pattern, based on the control data.

In this main process, it is repetitively carried out the processes of the steps S220 to S270.

In the mean time, in the embodiment, the sub-CPU 301, which is the means for outputting the driving signal, receives the information of the flag for notifying a game beforehand from the main CPU 201 and outputs the driving signal when the other condition is fulfilled (for example, when the identification information, which is determined (sampled) from the vibration pattern table shown in FIG. 11 on the basis of the flag for notifying a game beforehand, is matched to the figure ID of the figure 40 mounted to the base 50), thereby causing the vibration generating device 60 to generate the vibration as the preliminary notice (premonition) of the big win. However, the invention is not limited thereto. For example, it may be possible to generate the vibration in the vibration generating device 60 so as to carry out an effect for increasing an interest in the game, depending on the gaming states.

For instance, the sub-CPU 301 may output a driving signal after it receives the information of the flag for notifying a game beforehand and then a big win game is started, or output a driving signal at the timing at which the big win game start command is received, thereby driving the base 50 with the timing at which the big win gaming state is started.

As a consequence, it is possible to increase the interest in the game when it is made a big win.

In addition, in the embodiment, it is possible to carry out the various preliminary notices (premonitions) through the driving of the base 50, in addition to the preliminary notice (premonition) of the big win.

For example, the sub-CPU 301, which is the means for outputting a driving signal, may output a driving signal, based on the effect command for preliminarily notifying a ready-to-win, thereby driving the base 50 as the preliminary notice (premonition) of a ready-to-win.

In addition, in the embodiment, the sub-CPU 301 selects the vibration pattern, based on the information of the flag for notifying a game beforehand, which is transmitted from the main CPU 201. However, the invention is not limited thereto and the vibration pattern may be selected on the basis of the information besides the information of the flag for notifying a game beforehand. For example, it may be possible to directly check the information of the stop symbol included in the variable display pattern command, without referring to the information of the flag for notifying a game beforehand, thereby selecting a vibration pattern.

In the mean time, in the embodiment, when the detachable decoration member (figure) is mounted to the base, if a predetermined condition is fulfilled, a predetermined pattern of the vibration is generated in the vibration generating device 60 to drive the base 50. However, it may be possible to display the effect information image (for example, an image of the figure 40 mounted to the base 50) relating to the decoration member (figure 40) in the display area 21a of the liquid crystal display device 21, together with the driving of the base 50. In addition, it may be possible to turn on the lamp or LED provided to the various places of the gaming machine and to generate the sound related to the decoration member (figure 40) mounted to the base 50 (for example, melody, tone color, effect sound, sing related to a figure) from the speakers 8a, 8b, with the driving of the base 50.

In addition, in the embodiment, the figure 40 may be prepared according to following (1) and (2).

(1) The figure 40 is received in a capsule having a diameter of about 7 cm and is purchased from a vending machine equivalent to a card vending machine for buying a pre-paid card so as to borrow a gaming ball.

(2) The figure 40 may be prepared through a present exchange when the number of gaming balls, which are obtained by playing a game with the pachinko gaming machine 1, reaches a predetermined number. The prepared figure 40 is used to play a next game with the pachinko gaming machine 1.

In addition, in the embodiment, a part for which the vibration is not desired, such as integrated circuit, may be positioned at a place in the main body 3 of the gaming machine, which place is not affected by the vibration. In addition, it may be possible to structure an arrangement which is not affected by the vibration, such as so-called floating structure.

As described above, since the base 50 is driven by the vibration generating device 60 when a predetermined condition is fulfilled (for example, when a gaming state becomes a big win gaming state), the decoration member (figure 40) mounted to the base 50 is correspondingly driven. Accordingly, it is possible to carry out an effect increasing an interest in a game.

By doing so, it is possible to provide the decoration member with a function of an effect device.

In addition, since the decoration member (figure 40) is detachably mounted, the player can separate and possess the decoration member (figure 40). Accordingly, it is possible to enable the player to feel a strong affection for the decoration member (figure 40).

In addition, according to the embodiment, since the sub-CPU 301, which is the means for outputting a driving signal, outputs a driving signal, based on the identification information (figure ID) memorized in the decoration member (figure 40), it is possible to carry out a driving (effect) related to the decoration member (figure 40), to increase a function as the effect device of the decoration member (figure 40) and to enable the player to feel a strong affection for the decoration member (figure 40).

In addition, according to the embodiment, since the sub-CPU 301, which is the means for outputting a driving signal, outputs a driving signal when the determined identification information (figure ID) is matched to the identification information (figure ID) of the decoration member (figure 40) mounted to the base 50, it is possible to make the timings of the driving (effect) different, depending on the decoration members (figure 40), to increase a function as an effect device of the decoration member (figure 40) and to enable the player to feel a strong affection for the decoration member (figure 40) because a feature depending on the decoration member (figure 40) is clearer.

In addition, since the sub-CPU 301, which is the means for outputting a driving signal, can output different driving signals in accordance with types of the big win (usual big win, probability-variable big win, etc.), it is possible to make types of the decoration member to be driven (effected) different in correspondence with the types of the big win. Accordingly, it is possible to enable the player to feel a strong affection for the decoration member (figure 40) because a feature depending on the decoration member (figure 40) is clearer.

In addition, according to the embodiment, when the main CPU 301, which is the big win gaming state determining means, determines the big win, it is possible to drive the base 50 before the special symbol in the special symbol display area of the liquid crystal display device 21 is stopped as a big win display mode (big win symbol) representing that it is made a big win. Accordingly, it is possible to carry out an effect as a preliminary notice (premonition) through the driving and to increase the function as an effect device of the decoration member (figure 40) much more.

In addition, according to the embodiment, since the vibration resulting from the driving of the base 50 is transmitted to the flow passage 65, it is possible to improve the flowing state of the game medium (gaming ball) in the flow passage 65 through the vibration, thereby preventing the gaming ball from being jammed.

In addition, according to the embodiment, when any one of the plural detachable decoration members (figures 40) having types different from each other is mounted to the base 50, it is possible to enable the base 50 to carry out the driving (effect) related to the driving signal corresponding to the identification information (figure ID) provided to the decoration member (figure 40). Therefore, it is possible to further increase the function as an effect device of the decoration member (figure 40) and to enable the player to feel a strong affection for the decoration member (figure 40).

In the above embodiment, it has been described the case where the invention is applied to the gaming machine whose main body is attached to the game base. However, the invention is not limited thereto. For example, the invention can be applied to the various gaming machines, such as pachi-slot gaming machine (slot machine), mah-jong, smart ball or various gaming machine equipped in a game arcade.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a main body of the gaming machine playing a game with a predetermined game medium;
a decoration member having a predetermined shape;
mounting means mounted to the main body, the decoration member being detachably mounted thereto;
driving signal output means for outputting a driving signal when a predetermined condition is fulfilled; and
driving means for driving the mounting means, based on a driving signal outputted from said driving signal output means.

2. The gaming machine according to claim 1, wherein the identification information is memorized in the decoration member, it is provided identification information reading means for reading out the identification information from said decoration member mounted to said mounting means and said driving signal output means outputs the driving signal, based on the identification information read out by said identification information reading means.

3. The gaming machine according to claim 2, wherein said driving signal output means determines predetermined identification information when a predetermined condition is fulfilled, and outputs the driving signal when the determined identification information is matched to the identification information read out by said identification information reading means.

4. The gaming machine according to claim 2, further comprising big win gaming state determining means for determining whether or not to shift a gaming state to a big win gaming state which is advantageous to a player, when a winning of a gaming ball is made in a winning opening provided to the main body of the gaming machine,
wherein said driving signal output means outputs a driving signal corresponding to the big win gaming state when the big win gaming state determining means determines to shift a gaming state to the big win gaming state.

5. The gaming machine according to claim 4, further comprising a changeable display device for variably displaying the identification symbol and said identification symbol variable display control means for controlling a variable display of an identification symbol for enabling said changeable display device to variably display the identification symbol,
wherein said identification symbol variable display control means stops the identification symbol as a predetermined big win display mode in said changeable display device after said big win gaming state determining means determines to shift a gaming state to the big win gaming state and said driving signal output means outputs the driving signal corresponding to the big win gaming state.

6. The gaming machine according to claim 1, further comprising a tray unit having a storing part for storing said game medium and a flow passage enabling the game medium to flow,
wherein said mounting means is positioned in said tray unit.

7. The gaming machine according to claim 1, wherein said driving signal output means outputs the driving signal corresponding to the identification information provided to each of the plural detachable decoration members having types different from each other.
